(19) United States
(12) Patent Application Publication
(10) Pub. No.: US 2026/0058507 A1
(43) Pub. Date: Feb. 26, 2026

(54) ELECTRIC WORK MACHINE

(71) Applicant: MAKITA CORPORATION, Anjo-shi (JP)

(72) Inventor: Fuminari FUJII, Anjo-shi (JP)

(73) Assignee: MAKITA CORPORATION, Anjo-shi (JP)

(21) Appl. No.: 19/306,524

(22) Filed: Aug. 21, 2025

(30) Foreign Application Priority Data
Aug. 23, 2024 (JP) 2024-143301

(51) Int. Cl. H02K 1/18; H02K 5/08; H02K 5/16; H02K 5/24; H02K 7/14; H02K 11/215

(52) U.S. Cl. CPC H02K 1/18; H02K 5/08; H02K 5/161; H02K 5/24; H02K 7/145; H02K 11/215

(57) ABSTRACT

One aspect of the present disclosure provides an electric work machine including a brushless DC motor and a housing. A first partial housing of the housing includes at least one first protruding portion and at least one second protruding portion, each protruding toward the brushless DC motor from an inner surface of the first partial housing. A second partial housing of the housing includes at least one third protruding portion and at least one fourth protruding portion, each protruding toward the brushless DC motor from an inner surface of the second partial housing. The second protruding portion is located in a position different from that of the first protruding portion in a circumferential direction of a rotation axis. The fourth protruding portion is located in a position different from that of the third protruding portion in the circumferential direction.

### CROSS-REFERENCE TO RELATED APPLICATIONS

The present application claims the benefit of Japanese Patent Application No. 2024-143301 filed on Aug. 23, 2024 with the Japan Patent Office, the entire disclosure of which is incorporated herein by reference.

### BACKGROUND

The present disclosure relates to an electric work machine with a brushless DC motor.

Japanese Unexamined Patent Application Publication No. 2016-103929 discloses an electric work machine with a brushless DC motor.

The brushless DC motor includes a stator and a housing.

The stator is arranged inside the housing. The housing has a projecting portion formed on an inner circumferential surface of the housing. The stator has a recess portion formed on an outer circumferential surface of the stator.

In this electric work machine, the stator is positioned relative to the housing by the recess portion and the projecting portion being fitted to each other. Due to the fitting between the recess portion and the projecting portion, relative position between the stator and the housing in an axial direction of a rotor does not change.

The projecting portion of the housing is arranged between an end surface of a stator core and an end surface of an insulator.

### SUMMARY

In the above-described electric work machine, since the projecting portion of the housing, the stator core, and the insulator are stacked in the axial direction, the axial dimension of the brushless DC motor may increase.

As the axial dimension of the brushless DC motor increases, the axial dimension of the electric work machine may also increase.

On the other hand, users of the electric work machines are demanding smaller electric work machines.

In one aspect of the present disclosure, it is desirable to be able to inhibit an electric work machine with a brushless DC motor from increasing in size.

In the present disclosure, it should be noted that the terms such as “first” and “second” are intended simply to distinguish elements from each other, and are not intended to limit the order or the number of the elements. The first element may be referred to as the second element, and similarly, the second element may be referred to as the first element. In addition, the first element may be included without the second element, and similarly, the second element may be included without the first element.

One aspect of the present disclosure provides an electric work machine including a brushless DC motor and a housing.

The brushless DC motor includes a rotor and a stator. The rotor is configured to rotate about a rotation axis. The stator surrounds the rotor.

The housing accommodates (or houses) the brushless DC motor therein.

The stator includes a stator core, and an insulator.

The stator core includes a yoke and teeth. The yoke surrounds the rotor. The teeth radially protrude inward from the yoke with respect to the rotation axis.

The insulator covers at least a portion of the stator core.

The housing includes a first partial housing and a second partial housing. The second partial housing faces the first partial housing. The housing accommodates the brushless DC motor between the first partial housing and the second partial housing.

The first partial housing includes at least one first protruding portion and at least one second protruding portion.

The at least one first protruding portion protrudes toward the brushless DC motor from an inner surface of the first partial housing. The at least one second protruding portion protrudes toward the brushless DC motor from the inner surface of the first partial housing. The at least one second protruding portion is located in a position different from that of the at least one first protruding portion in a circumferential direction of the rotation axis.

The second partial housing includes at least one third protruding portion and at least one fourth protruding portion.

The at least one third protruding portion protrudes toward the brushless DC motor from an inner surface of the second partial housing. The at least one fourth protruding portion protrudes toward the brushless DC motor from the inner surface of the second partial housing. The at least one fourth protruding portion is located in a position different from that of the at least one third protruding portion in the circumferential direction.

The stator core includes at least one first abutment portion and at least one third abutment portion.

The at least one first abutment portion is configured to abut on the at least one first protruding portion to thereby restrain the stator from moving in a first axial direction along the rotation axis with respect to the housing. The at least one third abutment portion is configured to abut on the at least one third protruding portion to thereby restrain the stator from moving in the first axial direction with respect to the housing.

The insulator includes at least one second abutment portion and at least one fourth abutment portion.

The at least one second abutment portion is configured to abut on the at least one protruding portion to thereby restrain the stator from moving, with respect to the housing, in a second axial direction that is opposite to the first axial direction. The at least one fourth abutment portion is configured to abut on the at least fourth protruding portion to thereby restrain the stator from moving in the second axial direction with respect to the housing.

In the electric work machine as described above, the brushless DC motor is inhibited from moving in the first axial direction or the second axial direction inside the housing by the at least one first protruding portion abutting on the at least one first abutment portion, the at least one third protruding portion abutting on the at least one third abutment portion, the at least one second protruding portion abutting on the at least one second abutment portion, or the at least fourth protruding portion abutting on the at least one fourth abutment portion.

In detail, the brushless DC motor (the stator, in detail) is inhibited from moving in the first axial direction inside the housing by the abutment between the at least one first protruding portion and the at least one first abutment portion or the abutment between the at least one third protruding portion and the at least one third abutment portion. The brushless DC motor (the stator, in detail) is inhibited from moving in the second axial direction inside the housing by the abutment between the at least one second protruding portion and the at least one second abutment portion or the abutment between the at least one fourth protruding portion and the at least one fourth abutment portion.

The at least one first protruding portion and the at least one second protruding portion protrude from mutually different positions. Accordingly, the at least one first protruding portion and the at least one second protruding portion each restrain the brushless DC motor from moving in different directions (in other words, the first axial direction and the second axial direction).

The at least one first protruding portion and the at least one second protruding portion do not overlap. Thus, the brushless DC motor can be reduced in size in the first axial direction or in the second axial direction, compared with if all of the at least one first protruding portion, the at least one second protruding portion, the at least one first abutment portion, and the at least one second abutment portion overlapped.

Similarly, since not all of the at least one third protruding portion, the at least one fourth protruding portion, the at least one third abutment portion, and the at least one fourth abutment portion overlap, the brushless DC motor can be reduced in size in the first axial direction or the second axial direction, compared with if all of these portions overlapped.

Accordingly, the electric work machine can be inhibited from increasing in size.

The at least one first abutment portion and the at least one first protruding portion may always abut each other. However, the at least one first abutment portion and the at least one first protruding portion do not necessarily always abut each other.

Specifically, the at least one first abutment portion may abut on the at least one first protruding portion, when the stator moves in the first axial direction with respect to the housing, to thereby restrain the stator from moving further in the first axial direction. In contrast, when the stator moves in the second axial direction with respect to the housing, the at least one first abutment portion may be spaced apart from the at least one first protruding portion.

The combination of the at least one third abutment portion with the at least one third protruding portion, the combination of the at least one second abutment portion with the at least one second protruding portion, and the combination of the at least one fourth abutment portion with the at least one fourth protruding portion may operate similarly to the combination of the at least one first abutment portion with the at least one first protruding portion.

In the combination of the at least one third abutment portion with the at least one third protruding portion, when the stator moves in the first axial direction with respect to the housing, the at least one third abutment portion may abut on the at least one third protruding portion to thereby restrain the stator from moving further in the first axial direction. In contrast, when the stator moves in the second axial direction with respect to the housing, the at least one third abutment portion may be spaced apart from the at least one third protruding portion.

In the combination of the at least one second abutment portion with the at least one second protruding portion, when the stator moves in the second axial direction with respect to the housing, the at least one second abutment portion may abut on the at least one second protruding portion to thereby restrain the stator from moving further in the second axial direction. In contrast, when the stator moves in the first axial direction with respect to the housing, the at least one second abutment portion may be spaced apart from the at least one second protruding portion.

In the combination of the at least one fourth abutment portion with the at least one fourth protruding portion, when the stator moves in the second axial direction with respect to the housing, the at least one fourth abutment portion may abut on the at least one fourth protruding portion to thereby restrain the stator from moving further in the second axial direction. In contrast, when the stator moves in the first axial direction with respect to the housing, the at least one fourth abutment portion may be spaced apart from the at least one fourth protruding portion.

### BRIEF DESCRIPTION OF THE DRAWINGS

Example embodiments of the present disclosure will be described hereinafter with reference to the accompanying drawings, in which:

FIG. 1 is an external view of an electric work machine according to an example first embodiment;

FIG. 2 is a first perspective view of a motor unit in the electric work machine of the first embodiment;

FIG. 3 shows an exploded perspective view of the motor unit, which corresponds to the first perspective view of the motor unit in the first embodiment;

FIG. 4 shows an exploded perspective view of a stator, a rotor, a fan, and a circuit board, which corresponds to the first perspective view of the motor unit in the first embodiment;

FIG. 5 is a perspective view showing an inner structure of a left partial housing of the first embodiment;

FIG. 6 is a second perspective view of the motor unit in the electric work machine of the first embodiment;

FIG. 7 shows an exploded perspective view of the motor unit, which corresponds to the second perspective view of the motor unit in the first embodiment;

FIG. 8 shows an exploded perspective view of the stator, the rotor, the fan, and the circuit board, which corresponds to the second perspective view of the motor unit in the first embodiment;

FIG. 9 shows an exploded perspective view of a first insulator, a stator core, a second insulator, and a conductive member, which corresponds to the first perspective view of the motor unit in the first embodiment;

FIG. 10 shows an explanatory view of the first insulator and the stator core of the first embodiment viewed from the front;

FIG. 11 shows an explanatory view of the stator core of the first embodiment viewed from the front;

FIG. 12 is an external view of a front side of the motor unit in the electric work machine of the first embodiment;

FIG. 13 is a cross-sectional view of the motor unit in FIG. 12 taken along line XIII-XIII;

FIG. 14 is a cross-sectional view of the motor unit in FIG. 12 taken along line XIV-XIV;

FIG. 15 is an external view of a left side of the motor unit in the electric work machine of the first embodiment;

FIG. 16 is a cross-sectional view of the motor unit in FIG. 15 taken along line XVI-XVI;

FIG. 17 is a first exploded perspective view of a second motor unit in a second electric work machine of a second embodiment;

FIG. 18 shows an exploded perspective view of the stator, the rotor, the fan, and the circuit board, which corresponds to the first exploded perspective view of the second motor unit of the second embodiment;

FIG. 19 is a perspective view showing an inner structure of a second left partial housing of the second embodiment;

FIG. 20 shows a second exploded perspective view of the second motor unit of the second embodiment;

FIG. 21 shows exploded perspective views of the stator, the rotor, the fan, and the circuit board, which corresponds to the second exploded perspective view in the second motor unit of the second embodiment;

FIG. 22 shows an exploded perspective view of the first insulator, the stator core, the second insulator, and the conductive member, which corresponds to the first exploded perspective view of the second motor unit in the second embodiment;

FIG. 23 is an explanatory view of a modified first insulator and a second stator core of the second embodiment viewed from the front;

FIG. 24 is an explanatory view of the modified first insulator and the second stator core of the second embodiment viewed from the rear.

FIG. 25 is an external view of a front side of the second motor unit in the second electric work machine of the second embodiment;

FIG. 26 is a cross-sectional view of the second motor unit in FIG. 25 taken along line XXVI-XXVI;

FIG. 27 is a cross-sectional view of the second motor unit in FIG. 25 taken along line XXVII-XXVII;

FIG. 28 is an external view of a left side of the second motor unit in the second electric work machine of the second embodiment;

FIG. 29 is a cross-sectional view of the second motor unit in FIG. 28 taken along line XXIX-XXIX;

FIG. 30 is a first perspective view of a third motor unit in a third electric work machine of a third embodiment;

FIG. 31 shows an exploded perspective view of the housing, which corresponds to the first perspective view of the third motor unit in the third embodiment;

FIG. 32 is a second perspective view of the third motor unit in the third electric work machine of the third embodiment;

FIG. 33 shows an exploded perspective view of the housing, which corresponds to the second perspective view of the third motor unit in the third embodiment;

FIG. 34 is an external view of a front side of the third motor unit in the third electric work machine of the third embodiment;

FIG. 35 is a cross-sectional view of the third motor unit in FIG. 34 taken along line XXXV-XXXV;

FIG. 36 is a cross-sectional view of the third motor unit in FIG. 34 taken along line XXXVI-XXXVI;

FIG. 37 is an external view of a left side of the third motor unit in the third electric work machine of the third embodiment;

FIG. 38 is a cross-sectional view of the third motor unit in FIG. 37 taken along line XXXVII-XXXVII;

FIG. 39 is a first perspective view of a fourth motor unit in a fourth electric work machine of a fourth embodiment;

FIG. 40 shows an exploded perspective view of the housing, which corresponds to the first perspective view of the fourth motor unit in the fourth embodiment;

FIG. 41 shows an exploded perspective view of the housing in the fourth embodiment;

FIG. 42 is an external view of a front side of the fourth motor unit in the fourth electric work machine of the fourth embodiment;

FIG. 43 is a cross-sectional view of the fourth motor unit in FIG. 42 taken along line XLIII-XLIII;

FIG. 44 is a cross-sectional view of the fourth motor unit in FIG. 42 taken along line XLIV-XLIV;

FIG. 45 is an external view of a left side of the fourth motor unit in the fourth electric work machine of the fourth embodiment; and

FIG. 46 is a cross-sectional view of the fourth motor unit in FIG. 45 taken along line XLVI-XLVI.

### DETAILED DESCRIPTION OF EXEMPLARY EMBODIMENTS

### 1. Overview of Embodiments

One embodiment may provide an electric work machine (or an electric power tool, or an electric-powered equipment, or a job-site device) including at least any one of:
Feature 1: a brushless DC motor;
Feature 2: a housing accommodating the brushless DC motor therein;
Feature 3: the brushless DC motor includes a rotor configured to rotate about a rotation axis;
Feature 4: the brushless DC motor includes a stator surrounding the rotor;
Feature 5: the stator includes a stator core;
Feature 6: the stator core includes a yoke surrounding the rotor;
Feature 7: the stator core includes teeth radially protruding inward from the yoke with respect to the rotation axis;
Feature 8: the stator includes an insulator covering at least a portion of the stator core;
Feature 9: the housing includes a first partial housing;
Feature 10: the housing includes a second partial housing facing the first partial housing;
Feature 11: the housing accommodates the brushless DC motor between the first partial housing and the second partial housing;
Feature 12: the first partial housing includes at least one first protruding portion protruding toward the brushless DC motor from an inner surface of the first partial housing;
Feature 13: the first partial housing includes at least one second protruding portion protruding toward the brushless DC motor from the inner surface of the first partial housing;
Feature 14: the at least one second protruding portion is located in a position different from that of the at least one first protruding portion in a circumferential direction of the rotation axis;
Feature 15: the second partial housing includes at least one third protruding portion protruding toward the brushless DC motor from the inner surface of the second partial housing;
Feature 16: the second partial housing includes at least one fourth protruding portion protruding toward the brushless DC motor from the inner surface of the second partial housing;
Feature 17: the at least one fourth protruding portion is located in a position different from that of the at least one third protruding portion in the circumferential direction;
Feature 18: the stator core includes at least one first abutment portion configured to abut on the at least one first protruding portion to thereby restrain the stator from moving in a first axial direction along the rotation axis with respect to the housing;
Feature 19: the stator core includes at least one third abutment portion configured to abut on the at least one third protruding portion to thereby restrain the stator from moving in the first axial direction with respect to the housing;
Feature 20: the insulator includes at least one second abutment portion configured to abut on the at least one second protruding portion to thereby restrain the stator from moving, with respect to the housing, in a second axial direction that is opposite to the first axial direction; and
Feature 21: the insulator includes at least one fourth abutment portion configured to abut on the at least one fourth protruding portion to thereby restrain the stator from moving in the second axial direction with respect to the housing.

The electric work machine including at least Features 1 through 21 can be inhibited from increasing in size.

One embodiment may include, in addition to or in place of at least any one of Features 1 through 21, at least any one of:
Feature 22: each of the at least one first abutment portion and the at least one third abutment portion includes at least one protruding abutment portion and/or at least one exposed abutment portion;
Feature 23: the at least one protruding abutment portion outwardly protrudes from the yoke with respect to the rotation axis; and
Feature 24: the at least one exposed abutment portion is exposed from the insulator.

In the electric work machine including at least Features 1 through 24, when each of the at least one first abutment portion includes the at least one protruding abutment portion, the at least one protruding abutment portion abuts on the at least one first protruding portion. When each of the at least one first abutment portion includes the at least one exposed abutment portion, the at least one exposed abutment portion abuts on the at least one first protruding portion. When each of the at least one third abutment portion includes the at least one protruding abutment portion, the at least one protruding abutment portion abuts on the at least one third protruding portion. When each of the at least one third abutment portion includes the at least one exposed abutment portion, the at least one exposed abutment portion abuts on the at least one third protruding portion.

One embodiment may include, in addition to or in place of at least any one of Features 1 through 24,
Feature 25: each of the at least one first abutment portion includes (i) two protruding abutment portions as the at least one protruding abutment portion, (ii) two exposed abutment portions as the at least one exposed abutment portion, or (iii) one protruding abutment portion as the at least one protruding abutment portion and one exposed abutment portion as the at least one exposed abutment portion.

In the electric work machine including at least Features 1 through 25, each of the at least one first abutment portion can take any form from the above items (i) through (iii) depending on application of the electric work machine.

One embodiment may include, in addition to or in place of at least any one of Features 1 through 25,
Feature 26: each of the at least one third abutment portion includes (i) two protruding abutment portions as the at least one protruding abutment portion, (ii) two exposed abutment portions as the at least one exposed abutment portion, or (iii) one protruding abutment portion as the at least one protruding abutment portion and one exposed abutment portion as the at least one exposed abutment portion.

In the electric work machine including at least Features 1 through 24 and 26, each of the at least one third abutment portion can take any form from the above items (i) through (iii) depending on application of the electric work machine.

One embodiment may include, in addition to or in place of at least any one of Features 1 through 26,
Feature 27: each of the at least one second abutment portion and the at least one fourth abutment portion includes at least one outer arrangement portion arranged farther outward than the yoke in a radial direction of the rotation axis.

In the electric work machine including at least Features 1 through 21 and 27, each of the at least one second abutment portion can easily abut on a corresponding one of the at least one second protruding portion by including the at least one outer arrangement portion, making it easier to restrain the brushless DC motor from moving in the second axial direction. Each of the at least one fourth abutment portion can easily to abut on a corresponding one of the at least one fourth protruding portion by including the at least one outer arrangement portion, making it easier to restrain the brushless DC motor from moving in the second axial direction.

One embodiment may include, in addition to or in place of at least any one of Features 1 through 27,
Feature 28: each of the at least one second abutment portion includes two outer arrangement portions as the at least one outer arrangement portion.

In the electric work machine including at least Features 1 through 21, 27, and 28, since each of the at least one second abutment portion includes the two outer arrangement portions, it is possible to ensure a large area for abutting on each of the at least one second protruding portion.

One embodiment may include, in addition to or in place of at least any one of Features 1 through 28,
Feature 29: each of the at least one fourth abutment portion includes two outer arrangement portions as the at least one outer arrangement portion.

In the electric work machine including at least Features 1 through 21, 27, and 29, since each of the at least one fourth abutment portion includes the two outer arrangement portions, it is possible to ensure a large area for abutting on the at least one fourth protruding portion.

One embodiment may include, in addition to or in place of at least any one of Features 1 through 29, at least any one of:
Feature 30: the brushless DC motor includes a rotational position sensor configured to detect a rotational position of the rotor;
Feature 31: the insulator includes a first insulator including the at least one second abutment portion and/or the at least one fourth abutment portion;
Feature 32: the insulator includes a second insulator distinct from the first insulator; and
Feature 33: the rotational position sensor is fixed to the first insulator.

In the electric work machine including at least Features 1 through 21 and 30 through 33, since the first insulator includes the at least one second abutment portion and/or the at least one fourth abutment portion, the first insulator is supported by the at least one second protruding portion and/or the at least one fourth protruding portion. Since this allows the first insulator to be supported by the housing in a stable state, the rotational position sensor fixed to the first insulator is also supported in a stable state. Therefore, vibration-induced changes in relative position between the rotational position sensor and the rotor can be inhibited. Accordingly, it is possible to inhibit decreases in accuracy of detection of the rotational position of the rotor by the rotational position sensor.

One embodiment may include, in addition to or in place of at least any one of Features 1 through 33, at least any one of:
Feature 34: the stator includes coils wound around the teeth via the first insulator and the second insulator;
Feature 35: the stator includes a conductive member;
Feature 36: the conductive member includes a coupling portion coupled to the coils;
Feature 37: the conductive member includes a power receiving portion configured to receive electric power for the coils;
Feature 38: the first insulator, the stator core, and the second insulator are arranged in this order along the rotation axis; and
Feature 39: the conductive member is stacked on the yoke via the second insulator.

In the electric work machine including at least Features 1 through 21 and 30 through 39, the conductive member is arranged opposite the rotational position sensor across the stator core in the first axial direction or the second axial direction. The rotational position sensor and the conductive member are separated from each other, and do not interfere with each other.

One embodiment may include, in addition to or in place of at least any one of Features 1 through 39,
Feature 40: the first insulator, the stator core, and the second insulator are configured to be separable from each other.

In the electric work machine including at least Features 1 through 21, 30 through 33, and 40, a process to integrally form the first insulator, the stator core, and the second insulator becomes unnecessary. Thus, complexity in manufacturing the brushless DC motor can be reduced.

One embodiment may include, in addition to or in place of at least any one of Features 1 through 40,
Feature 41: the first partial housing and the second partial housing are formed of resin.

Resin can be more easily processed into various shapes than metal. Thus, in the electric work machine including at least Features 1 through 21 and 41, the first partial housing and the second partial housing can be formed into various shapes depending on applications or use environments.

One embodiment may include, in addition to or in place of at least any one of Features 1 through 41, at least any one of:
Feature 42: the brushless DC motor includes a first bearing rotatably supporting a first end of the rotor in the first axial direction;
Feature 43: the brushless DC motor includes a second bearing rotatably supporting a second end of the rotor in the second axial direction;
Feature 44: the housing includes a third partial housing;
Feature 45: the third partial housing covers an end of the brushless DC motor in the second axial direction;
Feature 46: the first partial housing and/or the second partial housing supports the first bearing; and
Feature 47: the third partial housing supports the second bearing.

In the electric work machine including at least Features 1 through 21 and 42 through 47, the third partial housing supports the second bearing. Thus, by inserting the rotor into the housing without the third partial housing, it is possible to arrange the rotor inside the housing. Alternatively, by removing the third partial housing from the housing, it is possible to remove the rotor from the housing.

One embodiment may include, in addition to or in place of at least any one of Features 1 through 47, at least any one of:
Feature 48: the first partial housing includes at least one fifth protruding portion protruding toward the brushless DC motor from the inner surface of the first partial housing;
Feature 49: the second partial housing includes at least one sixth protruding portion protruding toward the brushless DC motor from the inner surface of the second partial housing;
Feature 50: the stator core includes at least one fifth abutment portion configured to abut on the at least one fifth protruding portion to thereby restrain the stator from moving in the circumferential direction with respect to the housing; and
Feature 51: the stator core includes at least one sixth abutment portion configured to abut on the at least one sixth protruding portion to thereby restrain the stator from moving in the circumferential direction with respect to the housing.

In the electric work machine including at least Features 1 through 21 and 48 through 51, the stator can be restrained from moving in the circumferential direction with respect to the housing.

One embodiment may include, in addition to or in place of at least any one of Features 1 through 51,
Feature 52: the at least one first protruding portion of the first partial housing and the at least one third protruding portion of the second partial housing face each other across the brushless DC motor with the first partial housing and the second partial housing facing each other.

In the electric work machine including at least Features 1 through 21 and 52, the brushless DC motor can be supported in a well-balanced state by the at least one first protruding portion and the at least one third protruding portion facing each other across the brushless DC motor. As a result, vibration caused by driving of the brushless DC motor can be reduced.

In such a configuration, the at least one first protruding portion and the at least one third protruding portion can be symmetrically arranged across a boundary between the first and second partial housings.

One embodiment may include, in addition to or in place of at least any one of Features 1 through 52,
Feature 53: the at least one second protruding portion of the first partial housing and the at least one fourth protruding portion of the second partial housing face each other across the brushless DC motor with the first partial housing and the second partial housing facing each other.

In the electric work machine including at least Features 1 through 21 and 53, the brushless DC motor can be supported in a well-balanced state by the at least one second protruding portion and the at least one fourth protruding portion facing each other across the brushless DC motor. As a result, vibration caused by driving of the brushless DC motor can be reduced.

In such a configuration, the at least one second protruding portion and the at least one fourth protruding portion can be symmetrically arranged across the boundary between the first and second partial housings.

One embodiment may include, in addition to or in place of at least any one of Features 1 through 53, at least any one of:
Feature 54: the first axial direction is a direction from the rotation axis toward a driven tool; and
Feature 55: the driven tool is configured to be driven by a rotational force of the brushless DC motor.

One embodiment may include, in addition to or in place of at least any one of Features 1 through 55,
Feature 56: the electric work machine is an electric impact driver.

One embodiment may include, in addition to or in place of at least any one of Features 1 through 56, at least any one of:
Feature 57: the at least one first abutment portion and the at least one first protruding portion are configured to abut on each other or be separated from each other in response to a change in a relative position of the stator with respect to the housing along the rotation axis;
Feature 58: the at least one third abutment portion and the at least one third protruding portion are configured to abut on each other or be separated from each other in response to a change in the relative position of the stator with respect to the housing along the rotation axis;
Feature 59: the at least one second abutment portion and the at least one second protruding portion are configured to abut on each other or be separated from each other in response to a change in the relative position of the stator with respect to the housing along the rotation axis; and
Feature 60: the at least one fourth abutment portion and the at least one fourth protruding portion are configured to abut on each other or be separated from each other in response to a change in the relative position of the stator with respect to the housing along the rotation axis.

In the electric work machine including at least Features 1 through 21 and 57 through 60, when the stator moves in the first axial direction with respect to the housing, the at least one first abutment portion abuts on the at least one first protruding portion and the stator can be restrained from moving further in the first axial direction. In addition, the at least one third abutment portion abuts on the at least one third protruding portion and the stator can be restrained from moving further in the first axial direction.

When the stator moves in the second axial direction with respect to the housing, the at least one first abutment portion can be moved away from the at least one first protruding portion. In addition, the at least one third abutment portion can be moved away from the at least one third protruding portion.

When the stator moves in the second axial direction with respect to the housing, the at least one second abutment portion abuts on the at least one second protruding portion and the stator can be restrained from moving further in the second axial direction. In addition, the at least one fourth abutment portion abuts on the at least one fourth protruding portion and the stator can be restrained from moving further in the second axial direction.

When the stator moves in the first axial direction with respect to the housing, the at least one second abutment portion can be moved away from the at least one second protruding portion. In addition, the at least one fourth abutment portion can be moved away from the at least one fourth protruding portion.

One embodiment may provide a method including at least any one of:
Feature 61: in response to a movement of a stator of a brushless DC motor in a first axial direction with respect to a housing of a motor unit in an electric work machine, bringing a first abutment portion and a third abutment portion of a stator core of the stator into abutment (or contact) with a first protruding portion and a third protruding portion of the housing, respectively;
Feature 62: the first protruding portion protrudes toward the brushless DC motor from an inner surface of a first partial housing of the housing;
Feature 63: the third protruding portion protrudes toward the brushless DC motor from an inner surface of a second partial housing of the housing;
Feature 64: the first axial direction is along a rotation axis of a rotor of the brushless DC motor;
Feature 65: in response to a movement of the stator in a second axial direction with respect to the housing, bringing a second abutment portion and a fourth abutment portion of the stator core into abutment (or contact) with a second protruding portion and a fourth protruding portion of the housing, respectively;
Feature 66: the second protruding portion protrudes toward the brushless DC motor from the inner surface of the first partial housing;
Feature 67: the second protruding portion is located in a position different from that of the first protruding portion in a circumferential direction of the rotation axis;
Feature 68: the fourth protruding portion protrudes toward the brushless DC motor from the inner surface of the second partial housing;
Feature 69: the fourth protruding portion is located in a position different from that of the third protruding portion in the circumferential direction; and
Feature 70: the second axial direction is opposite to the first axial direction.

According to the method including at least Features 61 through 70, the brushless DC motor can be reduced in size in the first axial direction or the second axial direction, and the electric work machine can be inhibited from increasing in size.

Examples of the electric work machine include, but are not limited to, various types of equipment configured for use in construction, manufacturing, gardening, civil engineering, and other job-sites, specifically, power tools for stone processing, metal processing, and wood processing; power tools for gardening; power tools for job-site environment; fan vests; fan jackets; electric wheelbarrows (or electric dollies); electric-assisted bicycles; and electric inflators.

Examples of the power tools include, but are not limited to, an electric chainsaw, an electric handheld saw, an electric blower, an electric hammer, an electric hammer drill, an electric drill, an electric screwdriver, an electric wrench, an electric impact driver, an electric impact wrench, an electric grinder, an electric circular saw, an electric reciprocating saw, an electric jigsaw, an electric cutter, an electric planer, an electric nailer (including a tacker), an electric hedge trimmer, an electric lawn mower, an electric grass trimmer, an electric bush cutter, an electric cleaner, an electric sprayer, an electric spreader, an electric dust collector (or an electric dust extractor), an electric trowell, an electric vibrator, an electric rammer, an electric compactor, an electric pump, an electric pile driver, an electric concrete saw, an electric screed, and an electric cut-off saw.

The electric work machine may be battery-operated or battery-powered. Specifically, the electric work machine may have a built-in battery. Alternatively, the electric work machine may be configured such that a battery pack is detachably attached thereto. The battery pack houses a battery therein.

In one embodiment, Features 1 through 70 may be combined in any combination.

In one embodiment, any of Features 1 through 70 may be excluded.

### 2. Specific Example Embodiments

Some specific example embodiments will be described hereinafter.

### 2-1. First Embodiment

The present first embodiment provides an electric work machine 1 in the form of an electric impact driver. The electric work machine 1 is merely an example, and the present disclosure can be applied to various types of electric work machines.

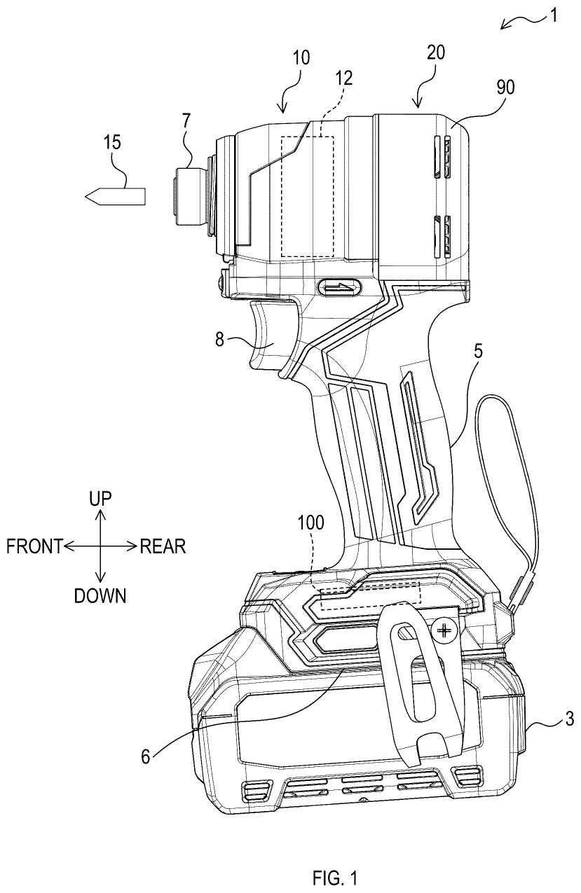

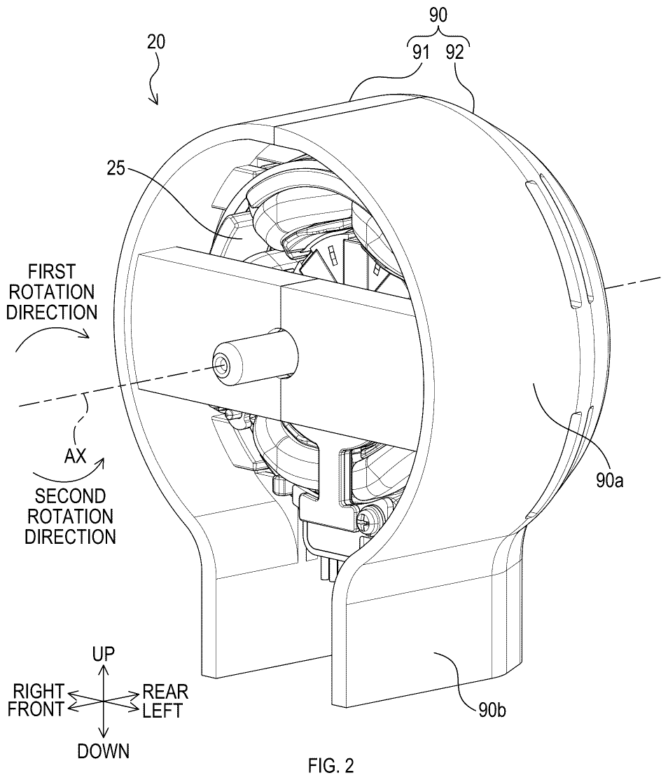

In the following description or the drawings, for convenience of explanation, directions “up,” “down,” “front,” “rear,” “left,” and “right” are defined as shown in FIGS. 1, 2, and so on. However, these directions are only used to facilitate easy understanding of the structure of the electric work machine 1, and are not intended to limit orientation of the electric work machine 1. The electric work machine 1 can be oriented in any direction.

### 2-1-1. Overall Configuration of Electric Work Machine

As shown in FIG. 1, the electric work machine 1 includes a head 10, a motor unit 20, a grip 5, a battery attachment portion 6, a chuck sleeve 7, and a trigger 8. The motor unit 20 is fixed to a rear end of the head 10. The motor unit 20 includes a motor 25 and a housing 90 to be described later. The chuck sleeve 7 is provided at a front end of the head 10.

The grip 5 is located below the head 10 and the motor unit 20, and extends downward. The grip 5 is configured to be gripped by a user of the electric work machine 1. The battery attachment portion 6 is located at a lower end of the grip 5. The battery attachment portion 6 is configured such that the battery pack 3 is detachably attached thereto. The battery pack 3 includes series-connected battery cells, and is rechargeable. Each battery cell is, but not limited to, a lithium ion battery.

The trigger 8 is located at an upper front of the grip 5. The trigger 8 is configured to be manually operated by the user. Specifically, the electric work machine 1 is configured such that the motor 25 rotates in response to the user pulling the trigger 8, and the motor 25 stops in response to the user releasing the trigger 8.

The head 10 houses therein a power transmitter 12. The power transmitter 12 is arranged in front of the motor unit 20, and mechanically coupled to the motor 25.

The chuck sleeve 7 is configured such that a driven tool 15 is detachably attached thereto. In the first embodiment, the driven tool 15 takes the form of various types of tool bits, for example. Examples of the various types of tool bits include, but are not limited to, a driver bit, a socket bit, and a drill bit.

The power transmitter 12 is mechanically coupled to the chuck sleeve 7 to transmit rotation of the motor 25 to the chuck sleeve 7. Thus, when the motor 25 rotates, the chuck sleeve 7 rotates together with the driven tool 15 attached thereto. In addition, the power transmitter 12 includes a striking mechanism (not shown). The striking mechanism applies to the chuck sleeve 7 a striking force in a rotation direction of the chuck sleeve 7 intermittently when a load applied from the chuck sleeve 7 exceeds a specified level. The load is applied in a direction opposite to the rotation direction of the chuck sleeve 7.

The grip 5 includes a controller 100 inside a lower end thereof. The controller 100 receives electric power from the battery pack 3 for operation, and controls the electric work machine 1. For example, the controller 100 controls drive currents supplied from the battery pack 3 to the motor 25 to thereby control driving of the motor 25.

### 2-1-2. Configuration of Motor Unit

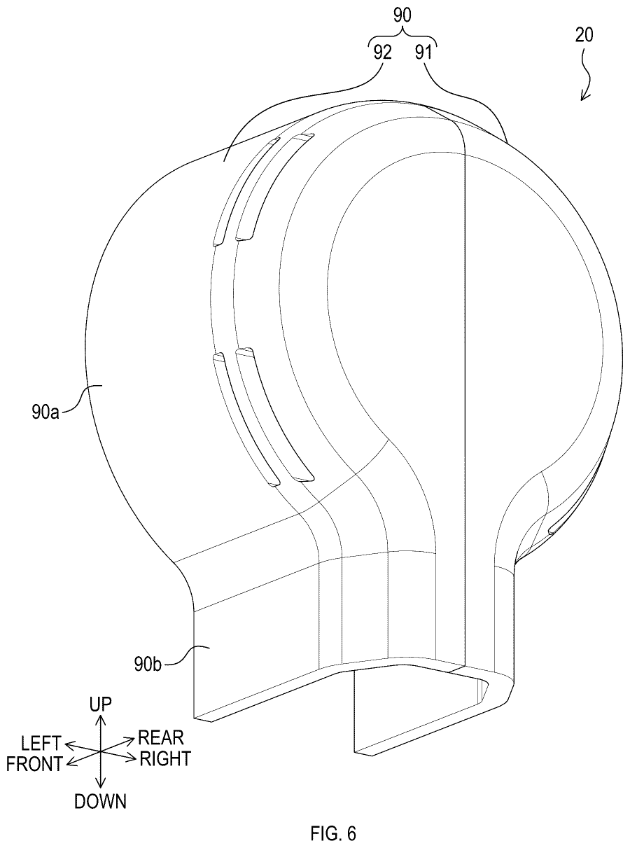

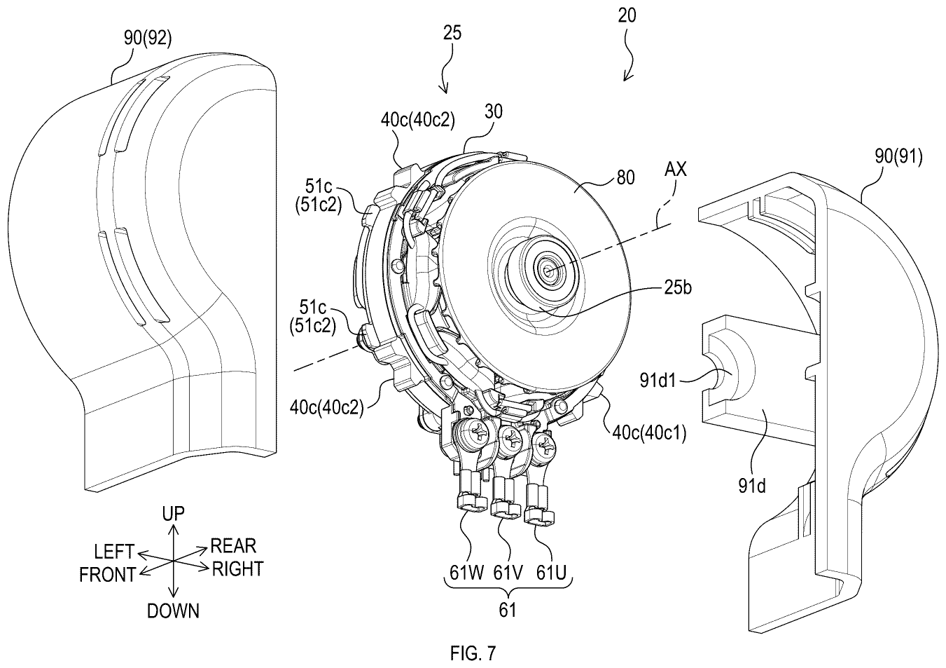

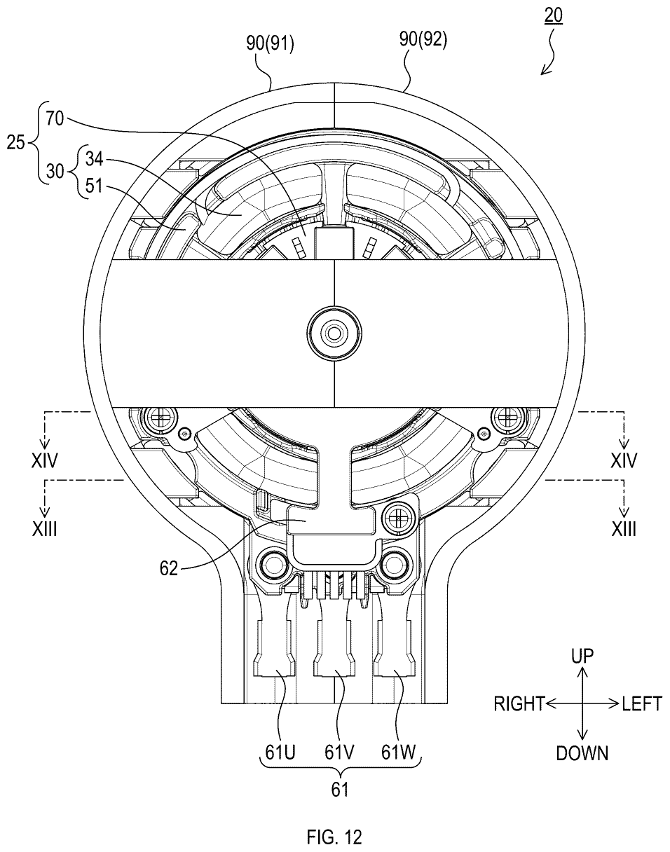

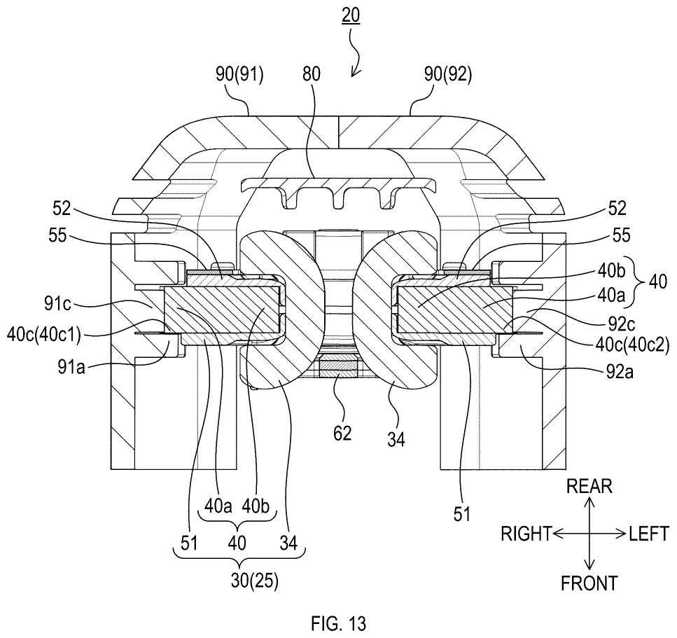

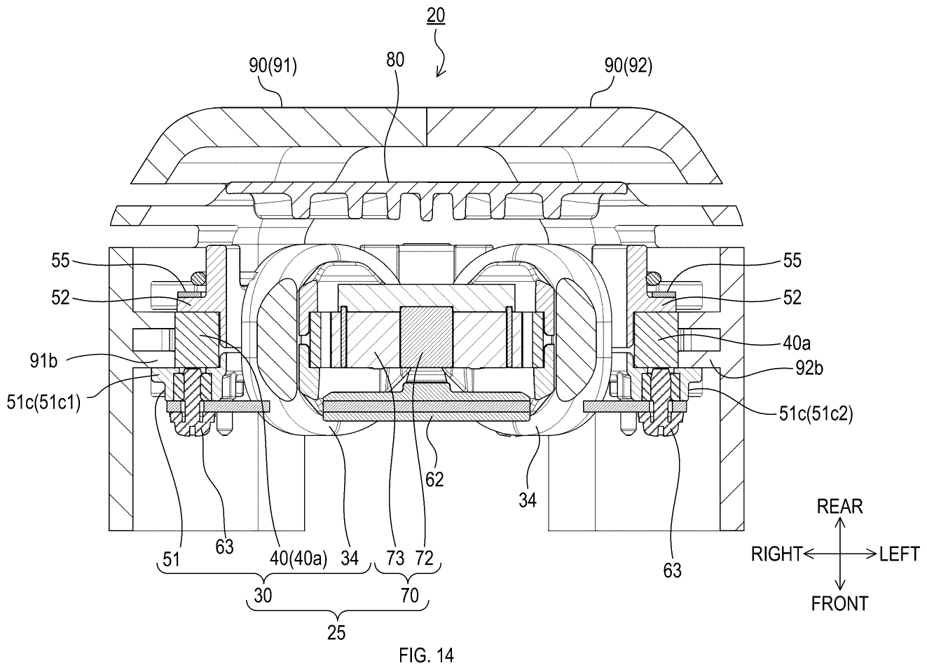

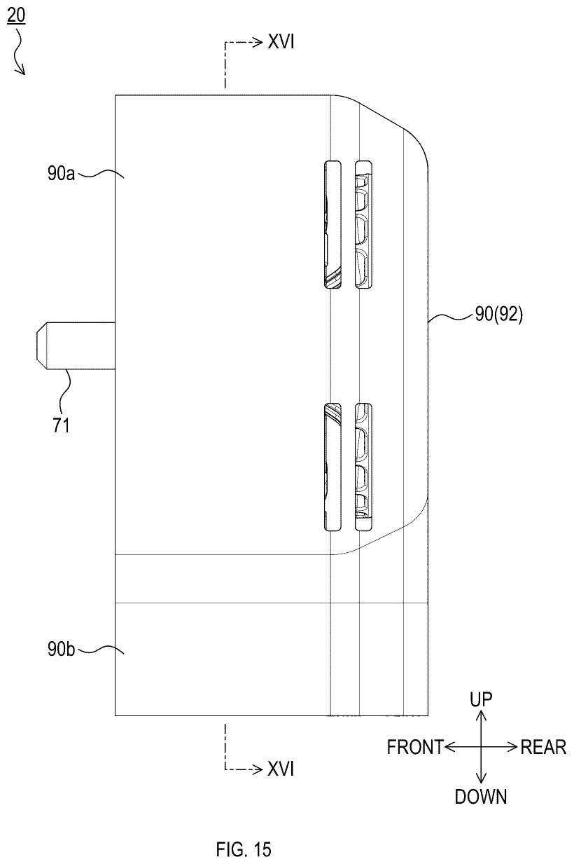

Referring to FIGS. 2 through 16, the motor unit 20 will be described.

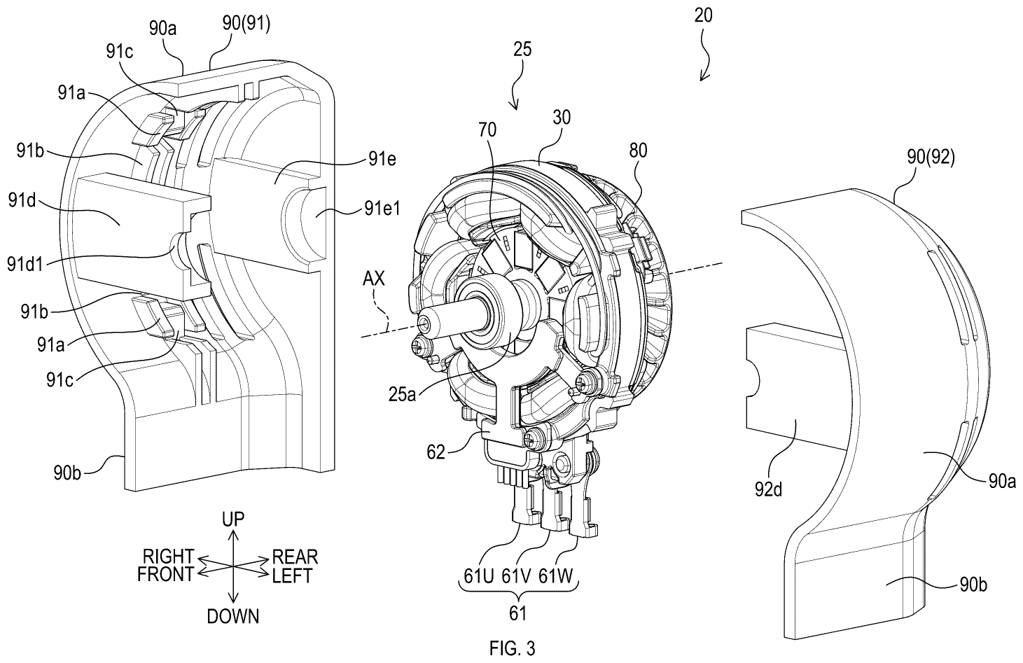

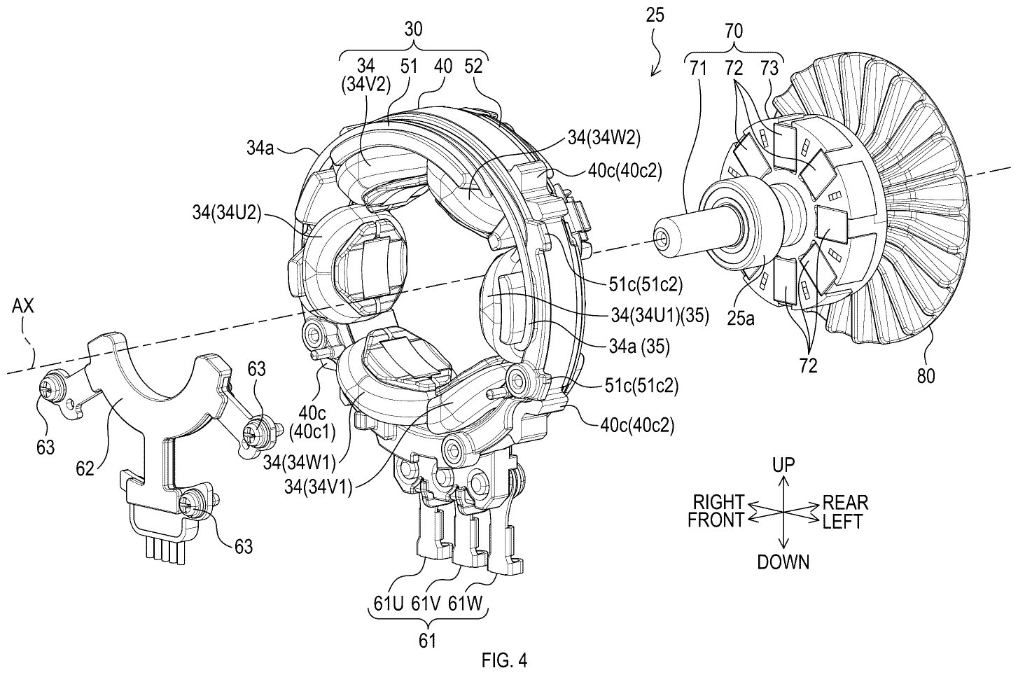

As shown in FIG. 3, the motor unit 20 includes the motor 25, a fan 80, a circuit board 62, and the housing 90. As shown in FIG. 4, the motor 25 includes a rotor 70 and a stator 30. As shown in FIGS. 3, 4, 7 and 8, the motor 25 includes a front bearing 25a and a rear bearing 25b. The front bearing 25a and the rear bearing 25b rotatably support the rotor 70.

The motor 25 of the present first embodiment is in the form of an inner-rotor three-phase brushless DC motor having a multiple of four magnetic poles (including four magnetic poles) and a multiple of three slots (including three slots). As an example combination of such number of poles (that is, number of magnetic poles) and number of slots, a combination of eight poles with six slots is exemplified in the present first embodiment. The motor 25 of the present first embodiment includes a U-phase, V-phase, and W-phase as three phases.

Hereinafter, directions parallel to a rotation axis AX of the motor 25 are referred to as “axial direction”. The axial direction coincides with front-rear directions. In the radial direction of the rotation axis AX, a position close to or a direction approaching the rotation axis AX is referred to as “radially inward”, and a position far from or a direction away from the rotation axis AX is referred to as “radially outward”. In the circumferential direction of the rotation axis AX, a clockwise direction and a counterclockwise direction, when viewed from the front toward the rear, are referred to as “first rotation direction”, and “second rotation direction, respectively.

### 2-1-3. Housing

As shown in FIGS. 2, 3, 12, 13 and 15, the housing 90 is configured to accommodate the motor 25 therein. The housing 90 is an electrical insulating member, and made of resin (for example, synthetic resin).

As shown in FIGS. 2, 6, 12 and 13, the housing 90 includes a cylindrical portion 90a and a protruding portion 90b. The cylindrical portion 90a has a cylindrical shape with a front side open and a rear side closed. The protruding portion 90b protrudes downward from a lower side of the cylindrical portion 90a. The protruding portion 90b houses later-described power supply terminals 61.

As shown in FIGS. 2, 3, 5 through 7 and 12 through 14, the housing 90 is configured to be separable into a right-partial housing 91 and a left-partial housing 92. The right-partial housing 91 forms a right side part of the housing 90. The left-partial housing 92 forms a left side part of the housing 90. The right-partial housing 91 is assembled from the right side of the motor 25 with respect to the stator 30. The left-partial housing 92 is assembled from the left side of the motor 25 with respect to the stator 30. The left-partial housing 92 is arranged to face the right-partial housing 91 to thereby house the motor 25 between the right-partial housing 91 and the left-partial housing 92.

As shown in FIGS. 3, 13, and 14, the right-partial housing 91 includes two first protruding portions 91a and a second protruding portion 91b. Each of the first protruding portions 91a protrudes toward the motor 25 from an inner surface of the right-partial housing 91. The second protruding portion 91b protrudes toward the motor 25 from a position on the inner surface of the right-partial housing 91 that differs from both of the first protruding portions 91a in the circumferential direction of the rotation axis AX.

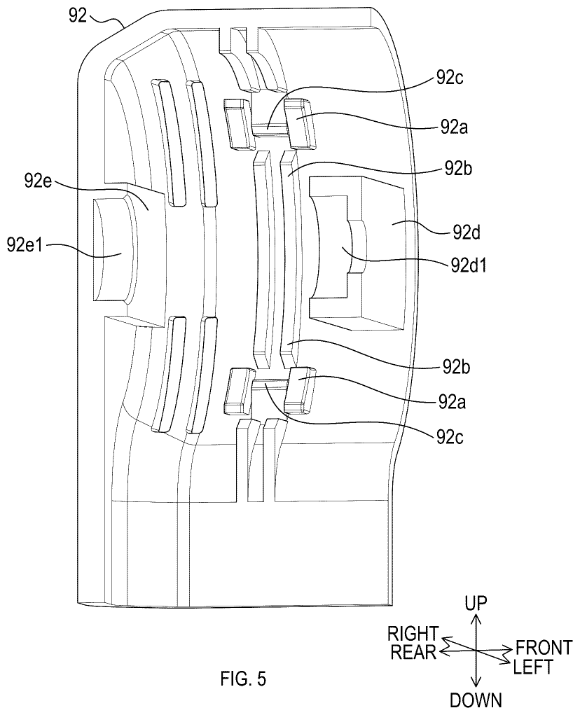

As shown in FIGS. 5, 13, and 14, the left-partial housing 92 includes two third protruding portions 92a and a fourth protruding portion 92b. Each of the third protruding portions 92a protrudes toward the motor 25 from an inner surface of the left-partial housing 92. The fourth protruding portion 92b protrudes toward the motor 25 from a position on the inner surface of the left-partial housing 92 that differs from both of the third protruding portions 92a in the circumferential direction of the rotation axis AX.

When the right-partial housing 91 and the left-partial housing 92 are arranged to face each other, each of the first protruding portions 91a of the right-partial housing 91 faces a corresponding one of the third protruding portions 92a of the left-partial housing 92 across the motor 25.

In addition, the second protruding portion 91b of the right-partial housing 91 faces the fourth protruding portion 92b of the left-partial housing 92 across the motor 25.

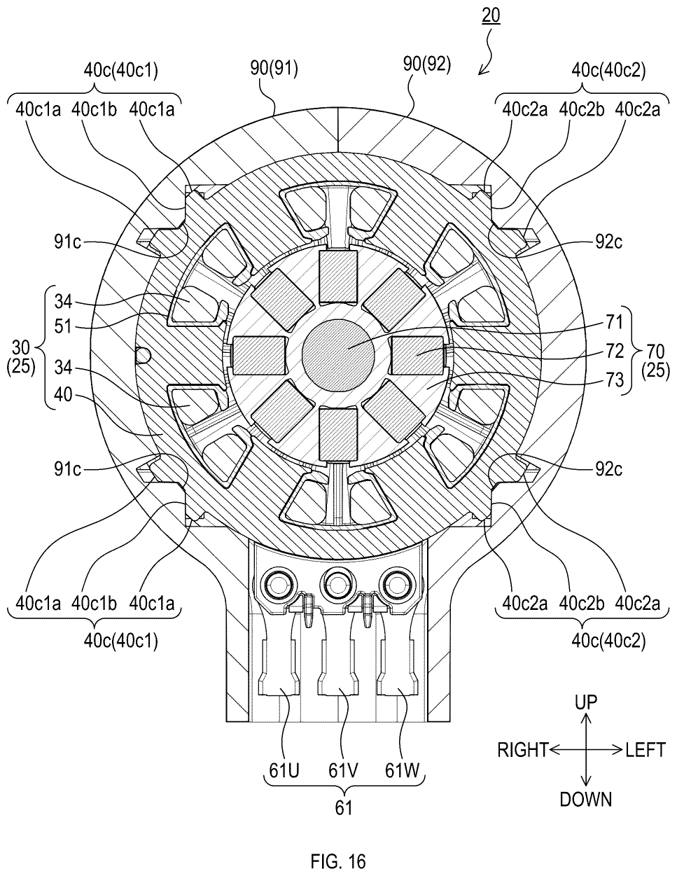

As shown in FIGS. 3 and 16, the right-partial housing 91 includes two fifth protruding portions 91c. Each of the fifth protruding portions 91c protrudes toward the motor 25 from the inner surface of the right-partial housing 91.

As shown in FIGS. 5 and 16, the left-partial housing 92 includes two sixth protruding portions 92c. Each of the sixth protruding portions 92c protrudes toward the motor 25 from the inner surface of the left-partial housing 92.

As shown in FIG. 3, the right-partial housing 91 includes a front bearing supporter 91d and a rear bearing supporter 91e. The front bearing supporter 91d protrudes toward the front bearing 25a of the motor 25 from the inner surface of the right-partial housing 91. The front bearing supporter 91d includes a front bearing abutment portion 91d1. The front bearing abutment portion 91d1 is configured to abut on the front bearing 25a. The rear bearing supporter 91e is formed on a rear inner surface of the right-partial housing 91. The rear bearing supporter 91e includes a rear bearing abutment portion 91e1. The rear bearing abutment portion 91e1 is configured to abut on the rear bearing 25b.

As shown in FIG. 5, the left-partial housing 92 includes a front bearing supporter 92d and a rear bearing supporter 92e. The front bearing supporter 92d protrudes toward the front bearing 25a of the motor 25 from the inner surface of the left-partial housing 92. The front bearing supporter 92d includes a front bearing abutment portion 92d1. The front bearing abutment portion 92d1 is configured to abut on the front bearing 25a. The rear bearing supporter 92e is formed on a rear inner surface of the left-partial housing 92. The rear bearing supporter 92e includes a rear bearing abutment portion 92e1. The rear bearing abutment portion 92e1 is configured to abut on the rear bearing 25b.

### 2-1-4. Rotor

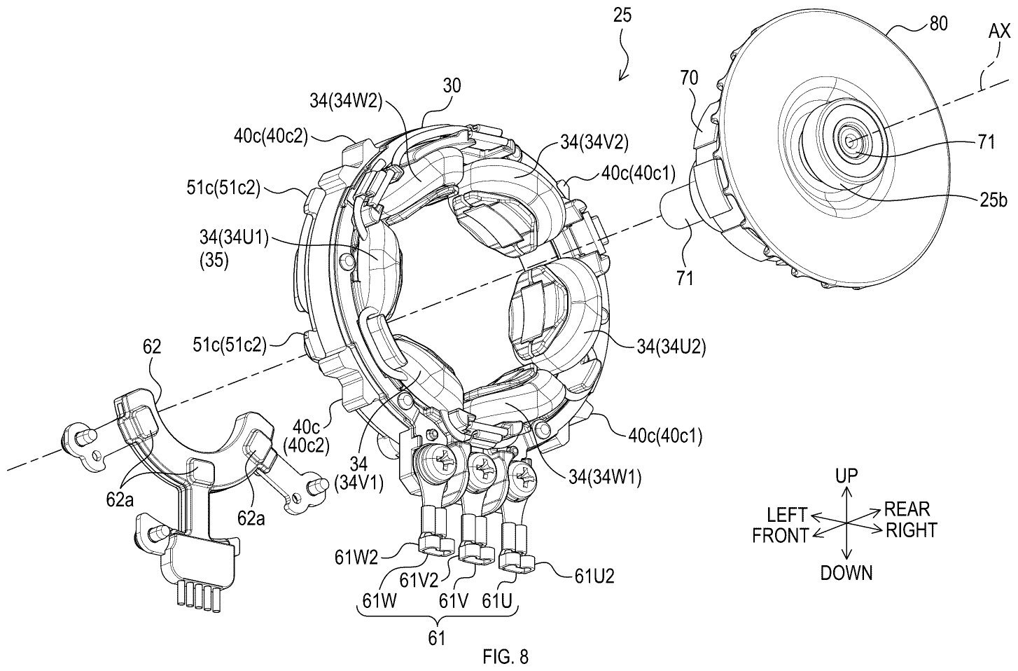

As shown in FIGS. 4 and 8, the rotor 70 includes a rotor shaft 71, magnetic pole portions 72, and a rotor core 73. The rotor 70 rotates about the rotation axis AX.

The rotor core 73 includes laminated steel plates. Each of the steel plates primarily contains iron. The rotor core 73 has an approximately cylindrical shape surrounding the rotation axis AX. The rotor core 73 includes, in its center, a through hole extending from its front surface to its rear surface.

The rotor shaft 71 is inserted in the through hole of the rotor core 73 so as to extend in the axial direction, and is fixed to the rotor core 73. A front part of the rotor shaft 71 protrudes forward from a front end of the rotor core 73, and is rotatably supported by the front bearing 25a. A rear part of the rotor shaft 71 protrudes rearward from a rear end of the rotor core 73, and is rotatably supported by the rear bearing 25b.

The magnetic pole portions 72 are arranged in the rotor core 73 at regular intervals in the circumferential direction of the rotation axis AX. Each of the magnetic pole portions 72 has a permanent magnet embedded in the rotor core 73. Each of the magnetic pole portions 72 extends from a radially inner side to a radially outer side of the rotor core 73. In other words, the magnetic pole portions 72 are arranged in a spoke-like configuration around the rotation axis AX. Each of the magnetic pole portions 72 has a north pole region and a south pole region. The magnetic pole portions 72 are arranged such that the same poles of the adjacent magnetic pole portions 72 along the circumferential direction face each other. In other words, a north pole of one magnetic pole portion 72 faces a north pole of another magnetic pole portion 72 adjacent in the circumferential direction. Also, a south pole of one magnetic pole portion 72 faces a south pole of another magnetic pole portion 72 adjacent in the circumferential direction. In the present first embodiment, the magnetic pole portions 72 include eight magnetic pole portions 72.

As shown in FIGS. 4 and 8, the fan 80 is arranged closer to a rear side of the rotor shaft 71 than the rotor core 73, and is fixed to the rear side of the rotor shaft 71. When the rotor shaft 71 rotates, the fan 80 rotates together with the rotor shaft 71.

### 2-1-5. Stator

As shown in FIGS. 4, 8, and 9, the stator 30 includes a stator core 40, a first insulator 51, a second insulator 52, coils 34, a conductive member 55, three power supply terminals 61, and three fixation screws 59.

The stator core 40 includes steel plates laminated in the axial direction. Each of the steel plates primarily contains iron.

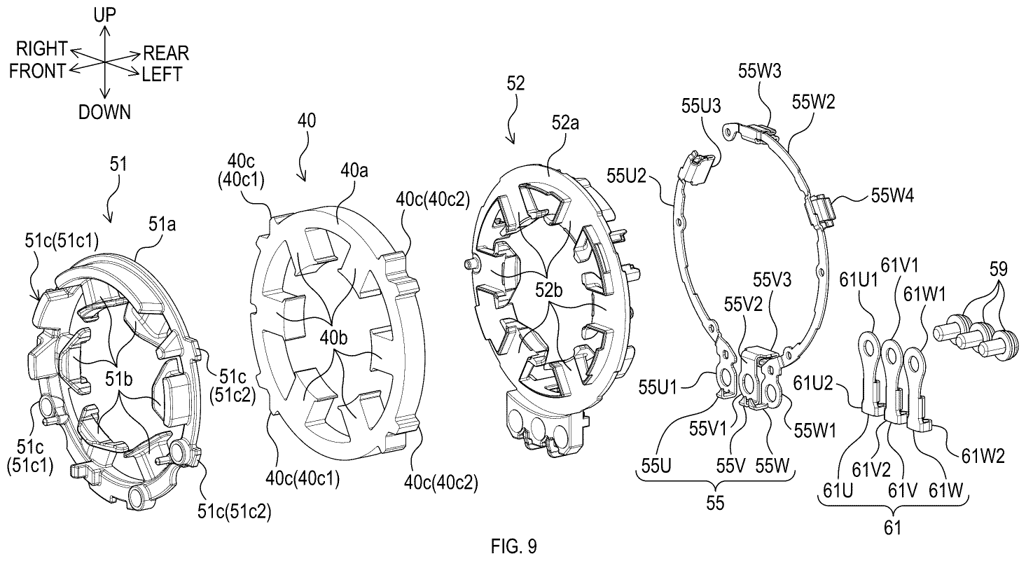

As shown in FIG. 9, the stator core 40 includes a yoke 40a and teeth 40b. The yoke 40a has a cylindrical or annular shape. The yoke 40a is arranged such that its center coincides with the rotation axis AX.

The teeth 40b protrude radially inward (in other words, toward the rotation axis AX) from an inner circumferential surface of the yoke 40a. The teeth 40b are arranged at equal intervals in the circumferential direction. The teeth 40b are integrally formed with the yoke 40a. In the present first embodiment, the teeth 40b have six teeth 40b.

As shown in FIG. 9, the first insulator 51 and the second insulator 52 are separately formed and fixed to the stator core 40. The first insulator 51 and the second insulator 52 are made of synthetic resin but may alternatively be made of another electrical insulating material. The first insulator 51 has a shape that covers a front side of the stator core 40. The second insulator 52 has a shape that covers a rear side of the stator core 40.

In other words, the first insulator 51 is fixed to the stator core 40 at the front side of the stator core 40, and covers a front side surface of the stator core 40. The second insulator 52 is fixed to the stator core 40 at the rear side of the stator core 40, and covers a rear side surface of the stator core 40.

The first insulator 51, the stator core 40, and the second insulator 52 configured as above can be separated from each other.

In another embodiment, the first insulator 51 and the second insulator 52 may be integrally formed to cover the stator core 40.

As shown in FIGS. 4, 8, and 9, the first insulator 51 includes a first main portion 51a and first teeth 51b. The first main portion 51a has a cylindrical or annular shape. The first main portion 51a is arranged such that its center coincides with the rotation axis AX.

The first teeth 51b protrudes radially inward (in other words, toward the rotation axis AX) from an inner circumferential surface of the first main portion 51a. In the present first embodiment, the first teeth 51b have six first teeth 51b. Each of the first teeth 51b is configured to cover a front side surface of a corresponding one of the teeth 40b of the stator core 40.

As shown in FIGS. 4, 8, and 9, the second insulator 52 includes a second main portion 52a and second teeth 52b. The second main portion 52a has a cylindrical or annular shape. The second main portion 52a is arranged such that its center coincides with the rotation axis AX.

The second teeth 52b protrude radially inward (in other words, toward the rotation axis AX) from an inner circumferential surface of the second main portion 52a. In the present first embodiment, the second teeth 52b have six second teeth 52b. Each of the second teeth 52b is configured to cover a rear side surface of a corresponding one of the teeth 40b of the stator core 40.

Each stator teeth is formed from a corresponding one of the teeth 40b, a corresponding one of the first teeth 51b, and a corresponding one of the second teeth 52b. In other words, the stator 30 of the present first embodiment includes six stator teeth.

The stator 30 includes a multiple of three slots (including three slots). The stator 30 of the present first embodiment includes six stator teeth as an example. Thus, the stator 30 of the present first embodiment includes six slots. Each of the six slots corresponds to a gap between two stator teeth adjacent to each other.

### 2-1-6. Coils

As shown in FIGS. 4 and 8, in the present first embodiment, the coils 34 have six coils 34. Each of the six coils 34 is provided on a corresponding one of the stator teeth. That is, each of the six coils 34 covers a portion of the stator core 40, a portion of the first insulator 51, and a portion of the second insulator 52 in a corresponding one of the stator teeth.

The coils 34 are wound around the teeth 40b of the stator core 40 via the first insulator 51 and the second insulator 52, and connected in series. In detail, each of the coils 34 is wound around a corresponding one of the teeth 40b via a corresponding one of the first teeth 51b and a corresponding one of the second teeth 52b. In other words, each of the six coils 34 is arranged around a corresponding one of the teeth 40b, a corresponding one of the first teeth 51b, and a corresponding one of the second teeth 52b. The six coils 34 and the stator core 40 are electrically insulated from each other by the first insulator 51 and the second insulator 52.

The six coils 34 are formed from a single magnetic wire 35. The coils 34 adjacent to each other in the circumferential direction are coupled by a connection line 34a which is part of the magnetic wire 35. The connection line 34a is positioned between one coil 34 and another coil 34, and is supported by the first insulator 51.

The three power supply terminals 61 are electrically coupled to the battery pack 3 via the controller 100. The battery pack 3 supplies the drive currents to the motor 25 via the controller 100. The controller 100 delivers the drive currents from the battery pack 3 to the motor 25, and excites the stator 30.

As shown in FIGS. 3, 4, and 7 through 9, in the present first embodiment, the power supply terminals 61 include a U-phase power supply terminal 61U, a V-phase power supply terminal 61V, and a W-phase power supply terminal 61W. The U-phase power supply terminal 61U receives a U-phase drive current. The V-phase power supply terminal 61V receives a V-phase drive current. The W-phase power supply terminal 61W receives a W-phase drive current.

As shown in FIGS. 4 and 8, the six coils 34 include three pairs of coils, and each pair of coils is assigned to any one of the U-phase, the V-phase, and the W-phase. In other words, a first pair of coils 34 is assigned to the U-phase, and includes a U-phase coil 34U1 and a U-phase coil 34U2. The U-phase coil 34U1 and the U-phase coil 34U2 are arranged to face each other in the radial direction. A second pair of coils 34 is assigned to the V-phase, and includes a V-phase coil 34V1 and a V-phase coil 34V2. The V-phase coil 34V1 and the V-phase coil 34V2 are arranged to face each other in the radial direction. A third pair of coils 34 is assigned to the W-phase, and includes a W-phase coil 34W1 and a W-phase coil 34W2. The W-phase coil 34W1 and the W-phase coil 34W2 are arranged to face each other in the radial direction.

In detail, in the circumferential direction, the V-phase coil 34V1 is arranged next to the U-phase coil 34U1, and the W-phase coil 34W1 is arranged next to the V-phase coil 34V1. The U-phase coil 34U2 is arranged next to the W-phase coil 34W1, and the V-phase coil 34V2 is arranged next to the U-phase coil 34U2. The W-phase coil 34W2 is arranged next to the V-phase coil 34V2, and the U-phase coil 34U1 is arranged next to the W-phase coil 34W2.

The controller 100 controls the drive currents flowing through the U-phase coil 34U1, the U-phase coil 34U2, the V-phase coil 34V1, the V-phase coil 34V2, the W-phase coil 34W1, and the W-phase coil 34W2 via the U-phase power supply terminal 61U, the V-phase power supply terminal 61V, and the W-phase power supply terminal 61W.

As shown in FIG. 9, the conductive members 55 are arranged on a rear side of the second insulator 52. The conductive members 55 are stacked on the yoke 40a via the second insulator 52 in the axial direction of the rotation axis AX. In other words, the conductive members 55 are electrically insulated from the stator core 40 by the second insulator 52. The conductive members 55 include conductive material.

The conductive members 55 include the same number of conductive members as the number of phases of the motor 25. In the present first embodiment, the conductive members 55 include a U-phase conductive member 55U, a V-phase conductive member 55V, and a W-phase conductive member 55W.

The U-phase conductive member 55U, the V-phase conductive member 55V, and the W-phase conductive member 55W are arranged on a rear side of the yoke 40a of the stator core 40 via the second insulator 52. The U-phase conductive member 55U, the V-phase conductive member 55V, and the W-phase conductive member 55W are each shaped to conform to a part of the annular portion of the yoke 40a.

The U-phase conductive member 55U includes a U-phase fixing hole portion 55U1, a U-phase extension 55U2 and a U-phase fusing terminal 55U3. The U-phase fixing hole portion 55U1 has a hole through which a fixation screw 59 can be inserted. The U-phase extension 55U2 is shaped to conform to a part of the annular portion of the yoke 40a. The U-phase extension 55U2 electrically couples the U-phase fixing hole portion 55U1 to the U-phase fusing terminal 55U3. The U-phase fusing terminal 55U3 is joined, through a fusing process, to the magnet wire 35 (not shown in FIG. 9) which forms the coils 34 and the connection lines 34a. The U-phase fusing terminal 55U3 is electrically coupled to the coils 34 and the connection lines 34a.

The fusing process is a method to thermally bond (or diffusion bond) a magnet wire to a fusing terminal using electrical resistance. The fusing process can, by applying pressure while heating, remove a portion of an insulating coating of the magnetic wire and, at the same time, crimp the magnetic wire to the fusing terminal. The fusing terminal may be a crimp terminal. The magnet wire may have an insulating coating.

The V-phase conductive member 55V includes a V-phase fixing hole portion 55V1, a V-phase extension 55V2, and a V-phase fusing terminal 55V3. The V-phase fixing hole portion 55V1 has a hole through which the fixation screw 59 can be inserted. The V-phase extension 55V2 is shaped to conform to a part of the annular portion of the yoke 40a. The V-phase extension 55V2 electrically couples the V-phase fixing hole portion 55V1 to the V-phase fusing terminal 55V3. The V-phase fusing terminal 55V3 is joined, through the fusing process, to the magnet wire 35 (not shown in FIG. 9) which forms the coils 34 and the connection lines 34a. The V-phase fusing terminal 55V3 is electrically coupled to the coils 34 and the connection lines 34a.

The W-phase conductive member 55W includes a W-phase fixing hole portion 55W1, a W-phase extension 55W2, a first W-phase fusing terminal 55W3, and a second W-phase fusing terminal 55W4. The W-phase fixing hole portion 55W1 has a hole through which the fixation screw 59 can be inserted. The W-phase extension 55W2 is shaped to conform to a part of the annular portion of the yoke 40a. The W-phase extension 55W2 electrically couples the W-phase fixing hole portion 55W1 to the first W-phase fusing terminal 55W3 and the second W-phase fusing terminal 55W4. Each of the first W-phase fusing terminal 55W3 and the second W-phase fusing terminal 55W4 is joined, through the fusing process, to the magnet wire 35 (not shown in FIG. 9) which forms the coils 34 and the connection lines 34a. Each of the first W-phase fusing terminal 55W3 and the second W-phase fusing terminal 55W4 is electrically coupled to the coils 34 and the connection lines 34a.

The U-phase power supply terminal 61U includes a U-phase fixing hole portion 61U1 and a U-phase crimping portion 61U2. The U-phase fixing hole portion 61U1 has a hole through which the fixation screw 59 can be inserted. The U-phase crimping portion 61U2 is configured to be crimped to a U-phase power wiring (not shown). The U-phase power wiring electrically couples the U-phase power supply terminal 61W to the battery pack 3 via the controller 100.

The V-phase power supply terminal 61V includes a V-phase fixing hole portion 61V1 and a V-phase crimping portion 61V2. The V-phase fixing hole portion 61V1 has a hole through which the fixation screw 59 can be inserted. The V-phase crimping portion 61V2 is configured to be crimped to a V-phase power wiring (not shown). The V-phase power wiring electrically couples the V-phase power supply terminal 61V to the battery pack 3 via the controller 100.

The W-phase power supply terminal 61W includes a W-phase fixing hole portion 61W1 and a W-phase crimping portion 61W2. The W-phase fixing hole portion 61W1 has a hole through which the fixation screw 59 can be inserted. The W-phase crimping portion 61W2 is configured to be crimped to a W-phase power wiring (not shown). The W-phase power wiring electrically couples the W-phase power supply terminal 61W to the battery pack 3 via the controller 100.

The three fixation screws 59 fix the U-phase conductive member 55U, the V-phase conductive member 55V, the W-phase conductive member 55W, the U-phase power supply terminal 61U, the V-phase power supply terminal 61V, and the W-phase power supply terminal 61W to the second insulator 52. With the three fixation screws 59, the U-phase conductive member 55U is electrically coupled to the U-phase power supply terminal 61U, the V-phase conductive member 55V is electrically coupled to the V-phase power supply terminal 61V, and the W-phase conductive member 55W is electrically coupled to the W-phase power supply terminal 61W.

### 2-1-7. Circuit Board

As shown in FIGS. 3, 4, and 8, the circuit board 62 is arranged on a front side of the first insulator 51. The circuit board 62 is fixed to the first insulator 51 by a screw 63.

As shown in FIG. 8, three Hall effect sensors 62a corresponding respectively to the U-phase, the V-phase, and the W-phase are mounted on a rear surface of the circuit board 62. The three Hall effect sensors 62a output detection signals to the controller 100 via signal lines (not shown). The controller 100 controls the drive currents delivered to the six coils 34 based on the detection signals received from the three Hall effect sensors 62a.

### 2-1-8. Abutment Portions of Stator Core and First Insulator

As shown in FIGS. 4, 7 through 11, 13, and 16, the yoke 40a of the stator core 40 includes abutment portions 40c. The abutment portions 40c are arranged at specified intervals on an outer circumferential surface of the yoke 40a. The abutment portions 40c protrude outward from the yoke 40a. The abutment portions 40c include two first abutment portions 40c1 and two third abutment portions 40c2. The two first abutment portions 40c1 are arranged in a right side region of the outer circumferential surface of the yoke 40a. The two third abutment portions 40c2 are arranged in a left side region of the outer circumferential surface of the yoke 40a.

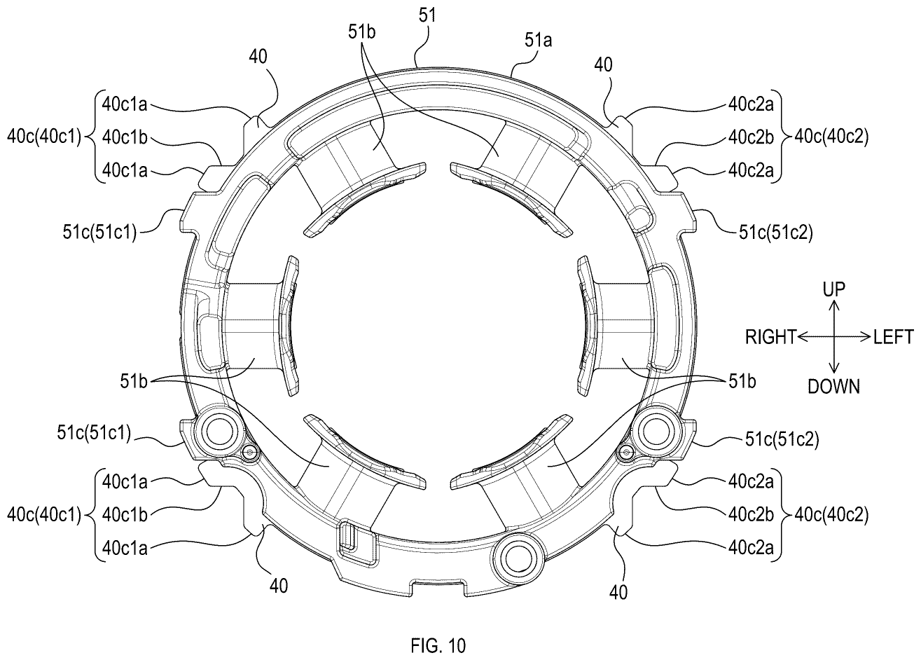

As shown in FIGS. 10, 11, and 16, each of the two first abutment portions 40c1 includes two first projections 40c1a and a first recess 40c1b. The two first projections 40c1a protrude radially outward on the outer circumferential surface of the yoke 40a. The first recess 40c1b is provided between the two first projections 40c1a on the outer circumferential surface of the yoke 40a.

Each of the two third abutment portions 40c2 includes two third projections 40c2a and a third recess 40c2b. The two third projections 40c2a protrude radially outward on the outer circumferential surface of the yoke 40a. The third recess 40c2b is provided between the two third projections 40c2a on the outer circumferential surface of the yoke 40a.

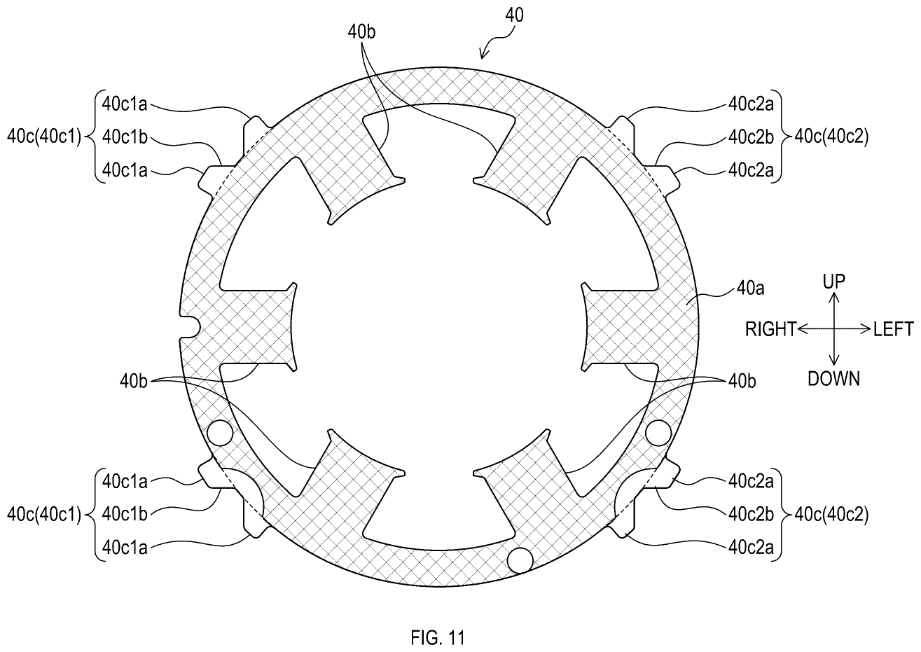

In FIG. 11, a region of the stator core 40 covered by the first insulator 51 is shown with a cross-hatched pattern. As can be seen from FIG. 11, the abutment portions 40c of the stator core 40 are exposed without being covered by the first insulator 51.

As shown in FIGS. 4 and 8 through 10, the first main portion 51a of the first insulator 51 includes abutment portions 51c. The abutment portions 51c are arranged at specified intervals on an outer circumferential surface of the first main portion 51a. The abutment portions 51c include two second abutment portions 51c1 and two fourth abutment portions 51c2. The two second abutment portions 51c1 are arranged in a right side region of the outer circumferential surface of the first main portion 51a. The two fourth abutment portions 51c2 are arranged on a left side region of the outer circumferential surface of the first main portion 51a.

Each of the two second abutment portions 51c1 protrudes radially outward on the outer circumferential surface of the first main portion 51a. Each of the two fourth abutment portions 51c2 protrudes radially outward on the outer circumferential surface of the first main portion 51a.

### 2-1-9. Fixing of Motor to Housing

Referring to FIGS. 2 through 16, fixing of the motor 25 (the stator 30 and the rotor 70, in detail) to the housing 90 (the right-partial housing 91 and the left-partial housing 92, in detail) will be described.

By assembling the right-partial housing 91 onto the motor 25 from the right side, and further assembling the left-partial housing 92 onto the motor 25 from the left side, the motor 25 is fixed between the right-partial housing 91 and the left-partial housing 92. At this point in time, the stator 30 and the rotor 70 of the motor 25 are separately fixed to the housing 90.

The stator 30 is assembled onto the right-partial housing 91 with each of the two first abutment portions 40c1 being in contact with or close to a corresponding one of the two first protruding portions 91a and each of the two second abutment portions 51c1 being in contact with or close to the second protruding portion 91b. The stator 30 is assembled onto the left-partial housing 92 with each of the two third abutment portions 40c2 being in contact with or close to a corresponding one of the two third protruding portions 92a and each of the two fourth abutment portions 51c2 being in contact with or close to the fourth protruding portion 92b.

When at least one of the two first abutment portions 40c1 abuts on the corresponding one of the two first protruding portions 91a or at least one of the two third abutment portions 40c2 abuts on the corresponding one of the two third protruding portions 92a, the stator 30 is restrained from moving forward inside the housing 90. In detail, when the first projections 40c1a of the first abutment portions 40c1 abut on the first protruding portions 91a or the third projections 40c2a of the third abutment portions 40c2 abut on the third protruding portions 92a, the stator 30 is restrained from moving forward.

When at least one of the two second abutment portions 51c1 abuts on the second protruding portion 91b or at least one of the two fourth abutment portions 51c2 abuts on the fourth protruding portion 92b, the stator 30 is restrained from moving rearward inside the housing 90.

The stator 30 is assembled onto the right-partial housing 91 with each of the two first abutment portions 40c1 being in contact with or close to a corresponding one of the two fifth protruding portions 91c. The stator 30 is assembled onto the left-partial housing 92 with each of the two third abutment portions 40c2 being in contact with or close to a corresponding one of the two sixth protruding portions 92c.

When at least one of the two first abutment portions 40c1 abuts on the corresponding one of the two fifth protruding portions 91c or at least one of the two third abutment portions 40c2 abuts on the corresponding one of the two sixth protruding portions 92c, the stator 30 is restrained from moving in the circumferential direction inside the housing 90. In detail, when the first recesses 40c1b of the first abutment portions 40c1 are in contact with the fifth protruding portions 91c or the third recesses 40c2b of the third abutment portions 40c2 are in contact with the sixth protruding portions 92c, a circumferential movement of the stator 30 is restrained. The circumferential movement restrained at this point in time includes movements in both the first rotation direction and the second rotation direction (see FIG. 2).

This maintains the stator 30 in a constant axial and circumferential position relative to the housing 90.

The rotor 70 is assembled onto the housing 90 with the front bearing 25a being in contact with the front bearing abutment portion 91d1 of the front bearing supporter 91d and the front bearing abutment portion 92d1 of the front bearing supporter 92d, and the rear bearing 25b being in contact with the rear bearing abutment portion 91e1 of the rear bearing supporter 91e and the rear bearing abutment portion 92e1 of the rear bearing supporter 92e.

In the motor unit 20, the first abutment portions 40c1 and the first protruding portions 91a are not always in contact with each other, but the first abutment portions 40c1 and the first protruding portions 91a can also be separated in accordance with changes in position of the stator 30 relative to the housing 90. More specifically, the first abutment portions 40c1 and the first protruding portions 91a abut on or are separated from each other in accordance with changes in position of the stator 30 relative to the housing 90 in the axial direction of the rotation axis AX.

When the stator core 40 moves forward with respect to the housing 90, the first abutment portions 40c1 abut on the first protruding portions 91a to thereby restrain further forward movement of the stator core 40. When the stator core 40 moves rearward with respect to the housing 90, the first abutment portions 40c1 are separated from the first protruding portions 91a.

The same applies to a combination of the third abutment portions 40c2 with the third protruding portions 92a, a combination of the second abutment portions 51c1 with the second protruding portion 91b, and a combination of the fourth abutment portions 51c2 with the fourth protruding portion 92b, as to the combination of the first abutment portions 40c1 with the first protruding portions 91a. In each combination, the abutment portions and the protruding portions are either in contact with or separated from each other in accordance with changes in position of the stator 30 relative to the housing 90.

Specifically, in the motor unit 20, when the stator core 40 moves forward with respect to the housing 90, the third abutment portions 40c2 abut on the third protruding portions 92a to thereby restrain the stator core 40 from further moving forward. When the stator core 40 moves rearward with respect to the housing 90, the third abutment portions 40c2 are separated from the third protruding portions 92a.

Further, in the motor unit 20, when the stator core 40 moves rearward with respect to the housing 90, the second abutment portions 51c1 abut on the second protruding portion 91b to thereby restrain the stator core 40 from further moving rearward. When the stator core 40 moves forward with respect to the housing 90, the second abutment portions 51c1 are separated from the second protruding portion 91b.

Further, in the motor unit 20, when the stator core 40 moves rearward with respect to the housing 90, the fourth abutment portions 51c2 abut on the fourth protruding portion 92b to thereby restrain the stator core 40 from further moving rearward. When the stator core 40 moves forward with respect to the housing 90, the fourth abutment portions 51c2 are separated from the fourth protruding portion 92b.

### 2-1-10. Effect

According to the first embodiment described above, the following effects are achieved.

(1) In the electric work machine 1, the axial movement of the motor 25 (the stator 30, in detail) inside the housing 90 is restrained by the first protruding portions 91a abutting on the first abutment portions 40c1, the third protruding portions 92a abutting on the third abutment portions 40c2, the second protruding portion 91b abutting on the second abutment portions 51c1, and/or the fourth protruding portion 92b abutting on the fourth abutment portions 51c2.

In detail, abutment between the first protruding portions 91a and the first abutment portions 40c1 or abutment between the third protruding portions 92a and the third abutment portions 40c2 inhibits the forward movement (i.e., the movement in the first axial direction) of the motor 25 (the stator 30, in detail) inside the housing 90. Abutment between the second protruding portion 91b and the second abutment portions 51c1 or abutment between the fourth protruding portion 92b and the fourth abutment portions 51c2 inhibits the rearward movement (i.e., the movement in the second axial direction) of the motor 25 (the stator 30, in detail) inside the housing 90.

At this point in time, the first protruding portions 91a and the second protruding portion 91b protruding from positions that differ from each other in the circumferential direction of the rotation axis AX restrain the movement of the motor 25 in different directions (in other words, the forward movement (i.e., the movement in the first axial direction) and the rearward movement (i.e., the movement in the second axial direction)).

In the electric work machine 1, since at least the first protruding portions 91a and the second protruding portion 91b are provided at the different positions in the circumferential direction, the first protruding portions 91a and the second protruding portion 91b do not overlap in the axial direction. Thus, the axial dimensions of the motor 25 can be reduced compared to one with all of the first protruding portions 91a, the second protruding portion 91b, the first abutment portions 40c1, and the second abutment portions 51c1 overlapped.

Similarly, since at least the third protruding portions 92a and the fourth protruding portion 92b do not overlap, the axial dimensions of the motor 25 can be reduced compared to one with all of the third protruding portions 92a, the fourth protruding portion 92b, the third abutment portions 40c2, and the fourth abutment portions 51c2 overlapped.

(2) In the electric work machine 1, since the first insulator 51 includes the second abutment portions 51c1 and/or the fourth abutment portions 51c2, the first insulator 51 is supported by the second protruding portion 91b and/or the fourth protruding portion 92b. As a result, the first insulator 51 can be supported by the housing 90 in a stable state, and the circuit board 62 (the Hall effect sensors 62a, in detail) fixed to the first insulator 51 can also be supported in a stable state.

Accordingly, since vibration-induced changes in the relative position between the Hall effect sensors 62a and the rotor 70 can be inhibited in the electric work machine 1, it is possible to inhibit vibration-induced decreases in accuracy of detection of the rotational position of the rotor 70 by the Hall effect sensors 62a.

(3) In the electric work machine 1, the conductive member 55 is arranged on the opposite side to the Hall effect sensors 62a across the stator core 40. As a result, the Hall effect sensors 62a and the conductive member 55 are separated from each other and do not interfere with each other.

Accordingly, in the electric work machine 1, decreases in the accuracy of detection (in other words, the accuracy in detection of the rotational position of the rotor 70) by the Hall effect sensors 62a, which are caused by interference between the Hall effect sensors 62a and the conductive member 55, can be inhibited.

(4) In the electric work machine 1, the first insulator 51, the stator core 40, and the second insulator 52 are configured to mate with each other. With this configuration, it is not necessary to manufacture the first insulator 51, the stator core 40, and the second insulator 52 in an integrated form. Thus, in the electric work machine 1, it is possible to reduce complexity of a process of manufacturing the motor 25.

(5) In the electric work machine 1, since the housing 90 (the right-partial housing 91 and the left-partial housing 92, in detail) is made of resin, the housing 90 is easily processed into any shape, compared to one made of metal. Thus, in the electric work machine 1, it is possible to form the housing 90 into various shapes depending on various conditions such as application and use environment.

(6) In the electric work machine 1, with the first abutment portions 40cl abutting on the fifth protruding portions 91c or the third abutment portions 40c2 abutting on the sixth protruding portions 92c, the stator 30 is inhibited from moving in the circumferential direction of the rotation axis AX inside the housing 90. Thus, in the electric work machine 1, changes in the relative position of the motor 25 (the stator 30, in detail) with respect to the housing 90 in the circumferential direction can be inhibited.

(7) In the electric work machine 1, since the first protruding portions 91a and the third protruding portions 92a are formed to face each other, and the second protruding portion 91b and the fourth protruding portion 92b are formed to face each other, the motor 25 can be supported in a balanced state.

Thus, in the electric work machine 1, even if vibration occurs, the housing 90 can support the motor 25 in a stable state.

(8) In the electric work machine 1, mutual abutment and separation occur in the combination of the first protruding portions 91a with the first abutment portions 40c1, the combination of the third protruding portions 92a with the third abutment portions 40c2, the combination of the second protruding portion 91b with the second abutment portions 51c1, and the combination of the fourth protruding portion 92b with the fourth abutment portions 51c2. This allows an appropriate gap between the housing 90 and the stator 30, thereby reducing complexity of assembling the motor 25 (the stator 30, in detail) onto the housing 90.

### 2-1-11. Correspondence Between Terms

The motor 25 corresponds to an example of the brushless DC motor in Overview of Embodiments. The right-partial housing 91 corresponds to an example of the first partial housing in Overview of Embodiments. The left-partial housing 92 corresponds to an example of the second partial housing in Overview of Embodiments.

The first abutment portions 40c1 and the third abutment portions 40c2 each correspond to an example of the at least one protruding abutment portion in Overview of Embodiments. The second abutment portions 51c1 and the fourth abutment portions 51c2 each correspond to an example of the at least one outer arrangement portion in Overview of Embodiments.

Each of the Hall effect sensors 62a corresponds to an example of the rotational position sensor in Overview of Embodiments.

Each of the first abutment portions 40c1 (the first recess 40c1b, in detail) corresponds to an example of the at least one fifth abutment portion in Overview of Embodiments. Each of the third abutment portions 40c2 (the third recess 40c2b, in detail) corresponds to an example of the at least one sixth abutment portion in Overview of Embodiments.

Forward corresponds to an example of the first axial direction in Overview of Embodiments. Rearward corresponds to an example of the second axial direction in Overview of Embodiments.

A combination of the U-phase fusing terminal 55U3, the V-phase fusing terminal 55V3, the W-phase fusing terminal 55W3, and the W-phase fusing terminal 55W4 corresponds to an example of the connector in Overview of Embodiments. A combination of the U-phase fixing hole portion 55U1, the V-phase fixing hole portion 55V1, and the W-phase fixing hole portion 55W1 corresponds to an example of the power receiving portion in Overview of Embodiments.

### 2-2. Second Embodiment 2-2-1. Differences from First Embodiment

The second embodiment has a basic configuration similar to the first embodiment, and the following describes the differences from the first embodiment. The same reference numerals as those in the first embodiment indicate the same components, and references are made to the preceding descriptions.

A second electric work machine 101 of the second embodiment differs from the electric work machine 1 of the first embodiment in that the second electric work machine 101 includes a second motor unit 120 in place of the motor unit 20.

### 2-2-2. Configuration of Motor Unit

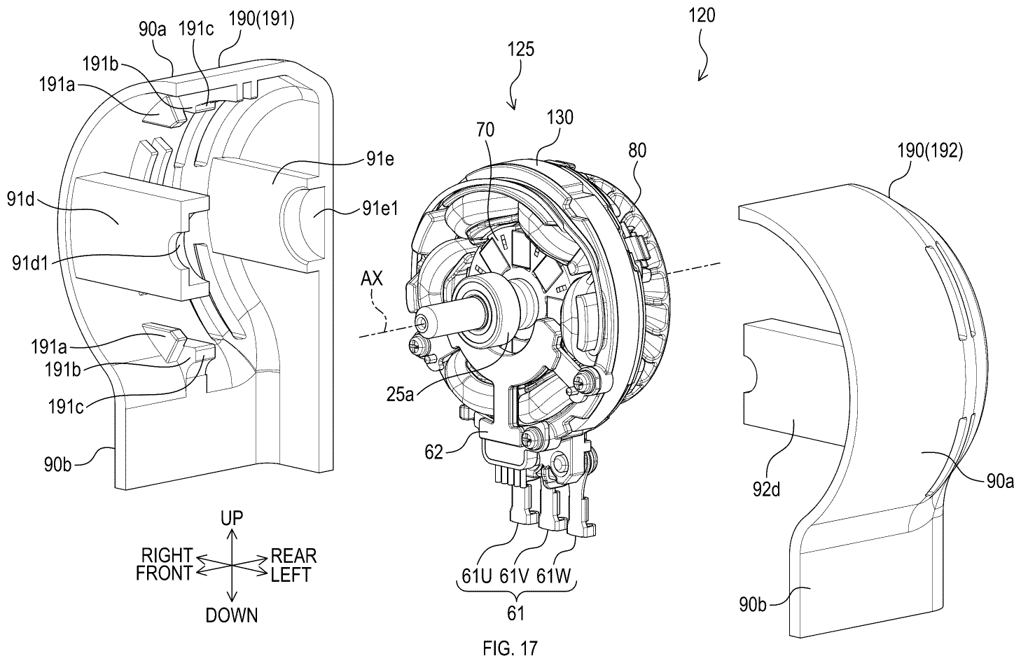

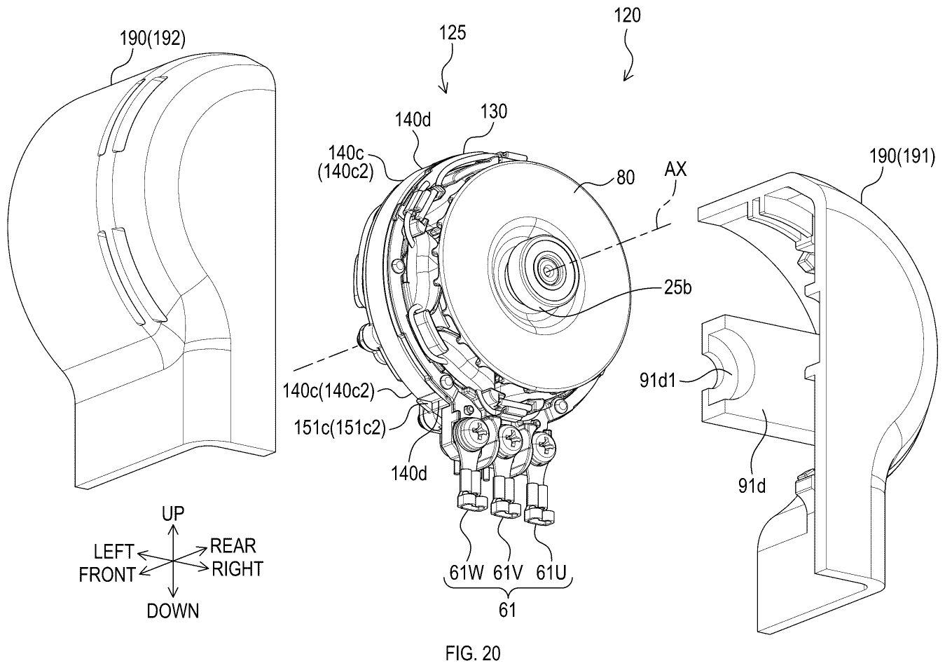

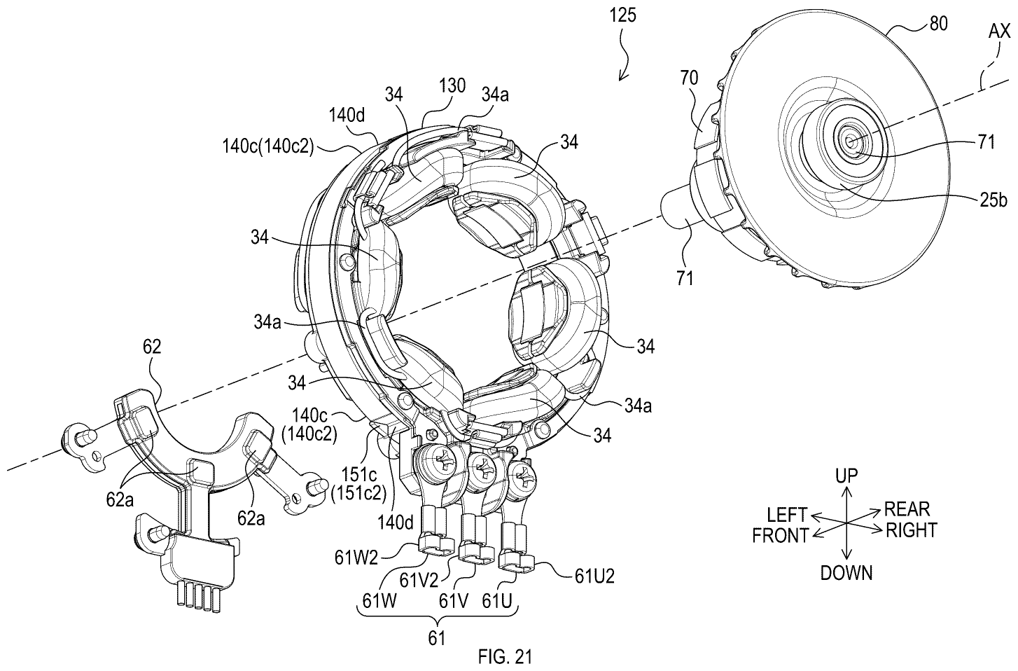

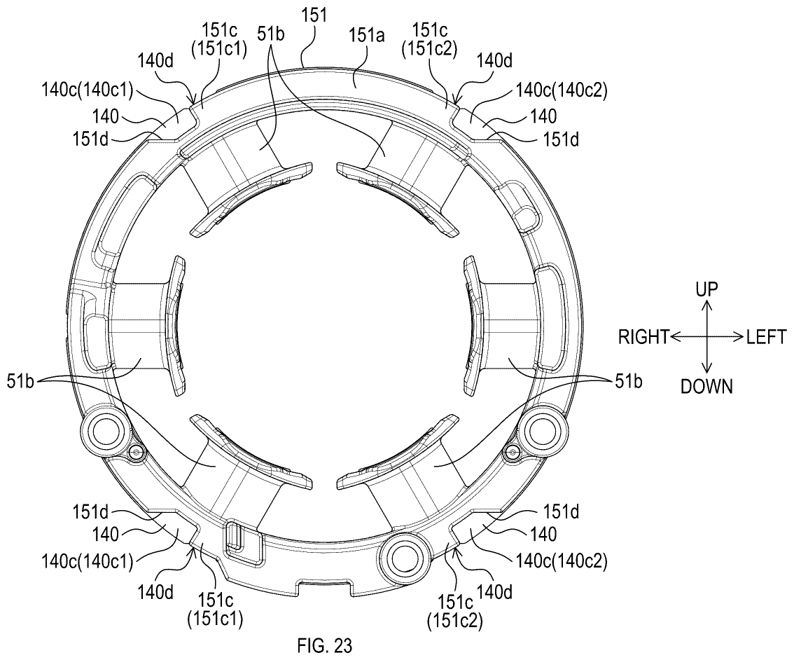

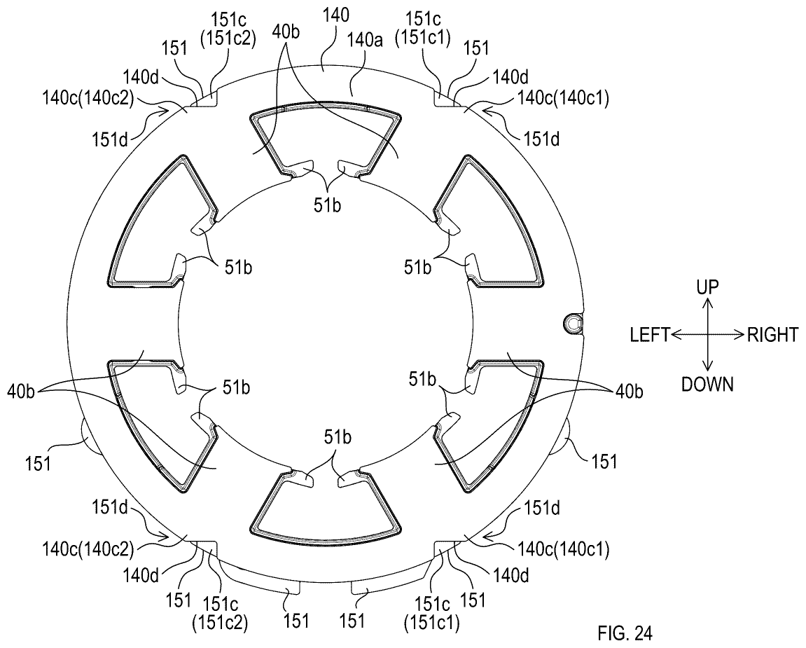

As shown in FIGS. 17 through 24, the second motor unit 120 differs from the motor unit 20 in that the second motor unit 120 includes a second housing 190 in place of the housing 90, and includes a second motor 125 in place of the motor 25.

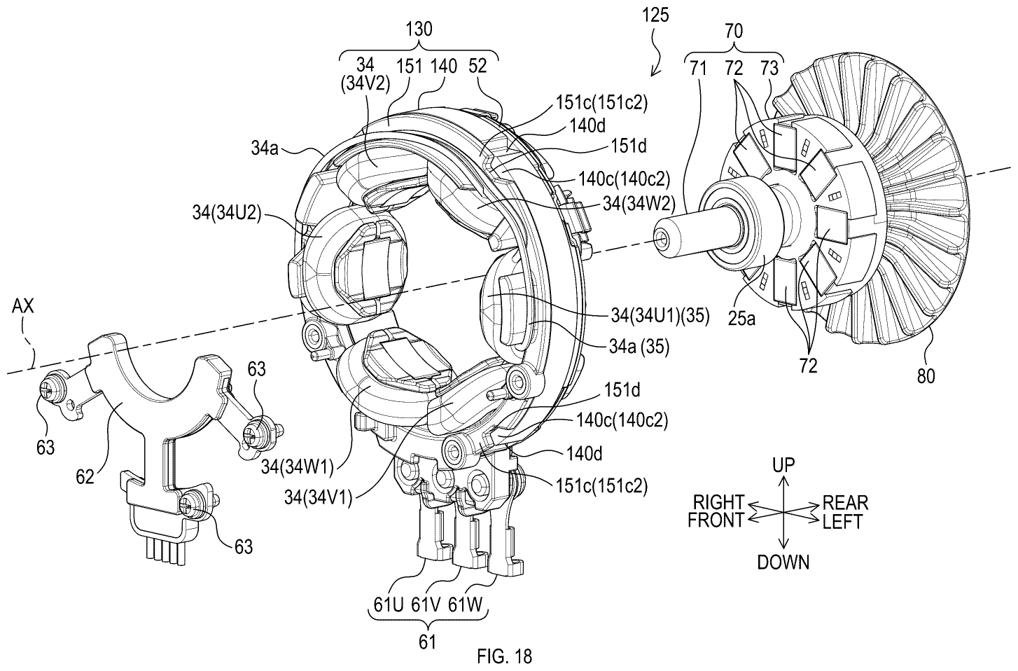

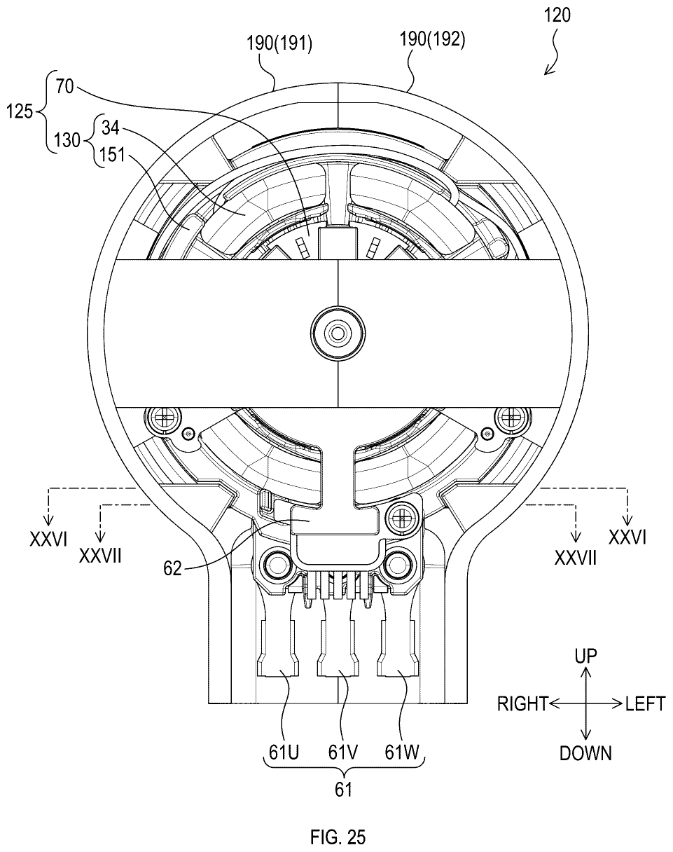

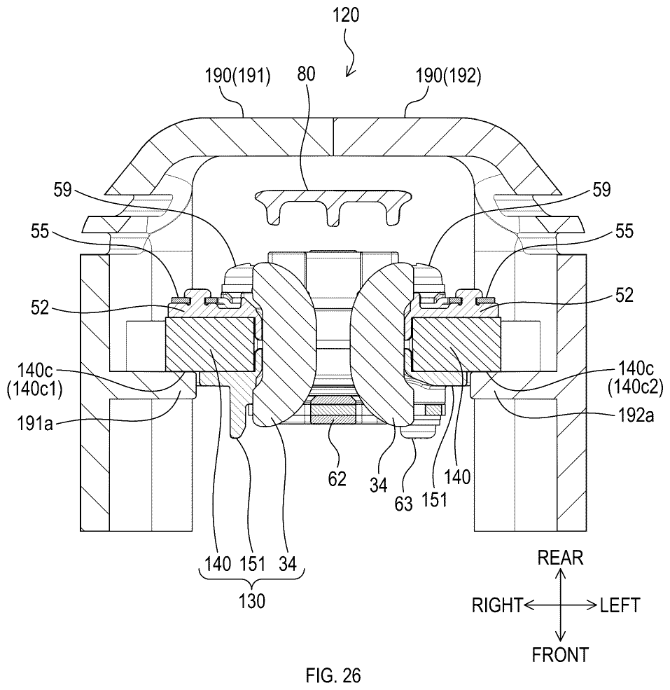

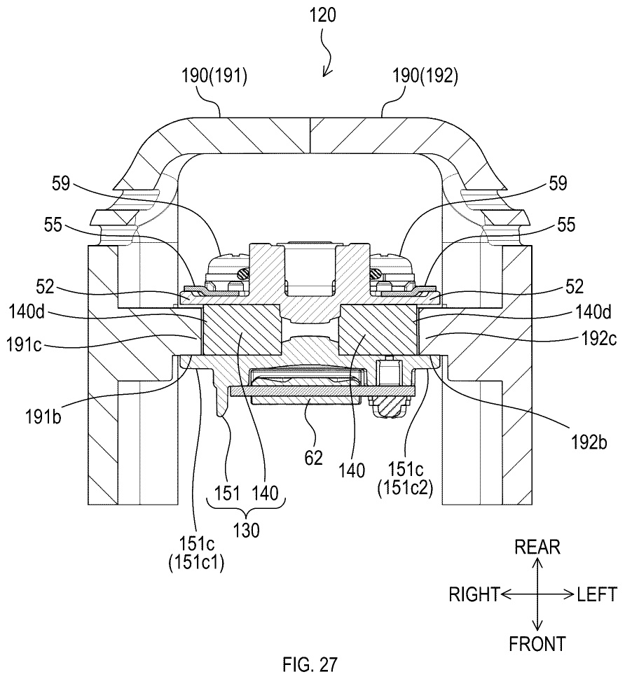

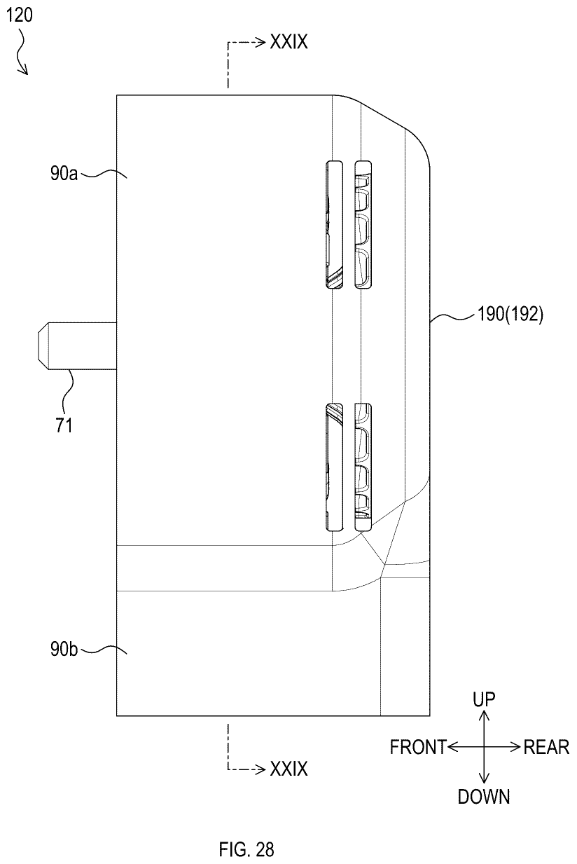

As shown in FIGS. 17, 25, and 28, the second motor unit 120 includes a second motor 125, the fan 80, the circuit board 62, and the second housing 190. As shown in FIGS. 18, 26, 27, and 29, the second motor 125 includes the rotor 70 and a second stator 130. The second motor 125 is also in the form of an inner-rotor three-phase brushless DC motor. As shown in FIGS. 17, 18, 20, and 21, the second motor 125 includes the front bearing 25a and the rear bearing 25b. The front bearing 25a and the rear bearing 25b rotatably support the rotor 70.

Similar to the motor 25, the second motor 125 of the present second embodiment has a multiple of four magnetic poles (including four magnetic poles) and a multiple of three slots (including three slots). The present second embodiment exemplifies a combination of eight poles with six slots. The second motor 125 of the present second embodiment includes a U-phase, a V-phase, and a W-phase as three phases.

### 2-2-3. Housing

As shown in FIGS. 17, 25, and 28, the second housing 190 is configured to accommodate the second motor 125 therein.

In terms of its appearance, the second housing 190 includes the cylindrical portion 90a and the protruding portion 90b, similar to the housing 90.

As shown in FIGS. 17, 19, 20, 26, 27, and 29, the second housing 190 is configured to be separable into a second right-partial housing 191 and a second left-partial housing 192. The second right-partial housing 191 forms a right side portion of the second housing 190. The second left-partial housing 192 forms a left side portion of the second housing 190. The second right-partial housing 191 is assembled from a right side onto the second stator 130 of the second motor 125. The second left-partial housing 192 is assembled from a left side onto the second stator 130 of the second motor 125. The second left-partial housing 192 is arranged to face the second right-partial housing 191 to thereby house the second motor 125 between the second right-partial housing 191 and the second left-partial housing 192.

As shown in FIGS. 17, 26, and 27, the second right-partial housing 191 includes two modified first protruding portions 191a and two modified second protruding portions 191b. Each of the modified first protruding portions 191a protrudes toward the second motor 125 from an inner surface of the second right-partial housing 191. Each of the modified second protruding portions 191b protrudes toward the second motor 125 from a position on the inner surface of the second right-partial housing 191 that differs from the modified first protruding portions 191a in the circumferential direction of the rotation axis AX.

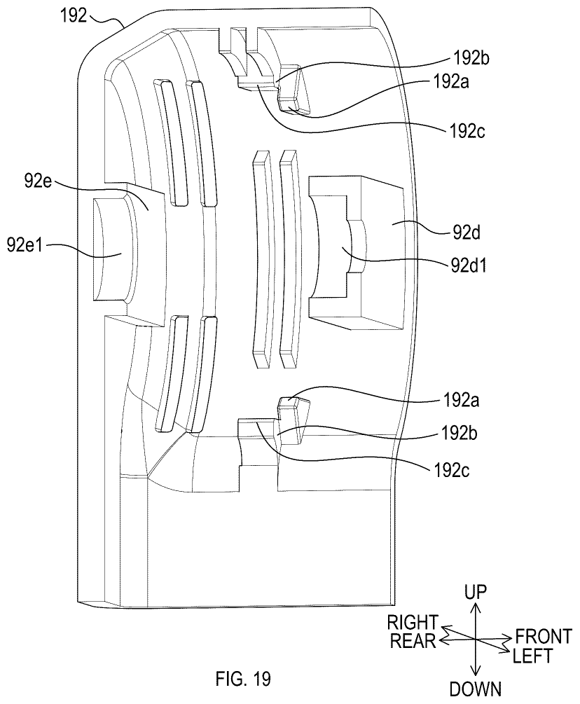

As shown in FIGS. 19, 26, and 27, the second left-partial housing 192 includes two modified third protruding portions 192a and two modified fourth protruding portions 192b. Each of the modified third protruding portions 192a protrudes from an inner surface of the second left-partial housing 192 toward the second motor 125. Each of the modified fourth protruding portions 192b protrudes toward the second motor 125 from a position on the inner surface of the second left-partial housing 192 that differs from the modified third protruding portions 192a in the circumferential direction of the rotation axis AX.

When the second right-partial housing 191 and the second left-partial housing 192 are arranged to face each other, each of the modified first protruding portions 191a of the second right-partial housing 191 faces a corresponding one of the modified third protruding portions 192a of the second left-partial housing 192 across the second motor 125.

In addition, each of the modified second protruding portions 191b of the second right-partial housing 191 faces a corresponding one of the modified fourth protruding portions 192b of the second left-partial housing 192 across the second motor 125.

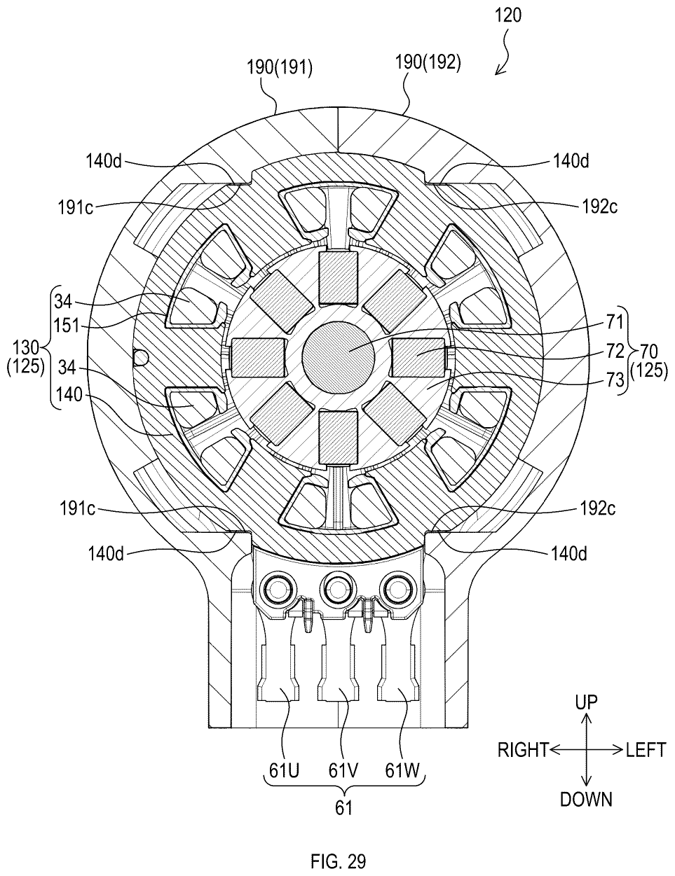

As shown in FIGS. 17 and 29, the second right-partial housing 191 includes two modified fifth protruding portions 191c. Each of the modified fifth protruding portions 191c protrudes toward the second motor 125 from the inner surface of the second right-partial housing 191.

As shown in FIGS. 19 and 29, the second left-partial housing 192 includes two modified sixth protruding portions 192c. Each of the modified sixth protruding portions 192c protrudes toward the second motor 125 from the inner surface of the second left-partial housing 192.

As shown in FIG. 17, the second right-partial housing 191 includes the front bearing supporter 91d and the rear bearing supporter 91e, similar to the right-partial housing 91. The front bearing abutment portion 91d1 of the front bearing supporter 91d abuts on the front bearing 25a of the second motor 125. The rear bearing abutment portion 91e1 of the rear bearing supporter 91e abuts on the rear bearing 25b of the second motor 125.

As shown in FIG. 19, the second left-partial housing 192 includes the front bearing supporter 92d and the rear bearing supporter 92e, similar to the left-partial housing 92. The front bearing abutment portion 92d1 of the front bearing supporter 92d abuts on the front bearing 25a of the second motor 125. The rear bearing abutment portion 92e1 of the rear bearing supporter 92e abuts on the rear bearing 25b of the second motor 125.

### 2-2-4. Rotor

The rotor 70 of the second motor 125 has the same configuration as that of the rotor 70 of the motor 25. Thus, the description here is not repeated.

### 2-2-5. Stator

As shown in FIGS. 18, 21, and 22, the second stator 130 includes a second stator core 140, a modified first insulator 151, the second insulator 52, the coils 34, the conductive member 55, the three power supply terminals 61, and the three fixation screws 59. The second stator 130 differs from the stator 30 in that the second stator 130 includes the second stator core 140 in place of the stator core 40, and the modified first insulator 151 in place of the first insulator 51.

The second stator core 140 includes steel plates laminated in the axial direction. Each of the steel plates primarily contains iron.

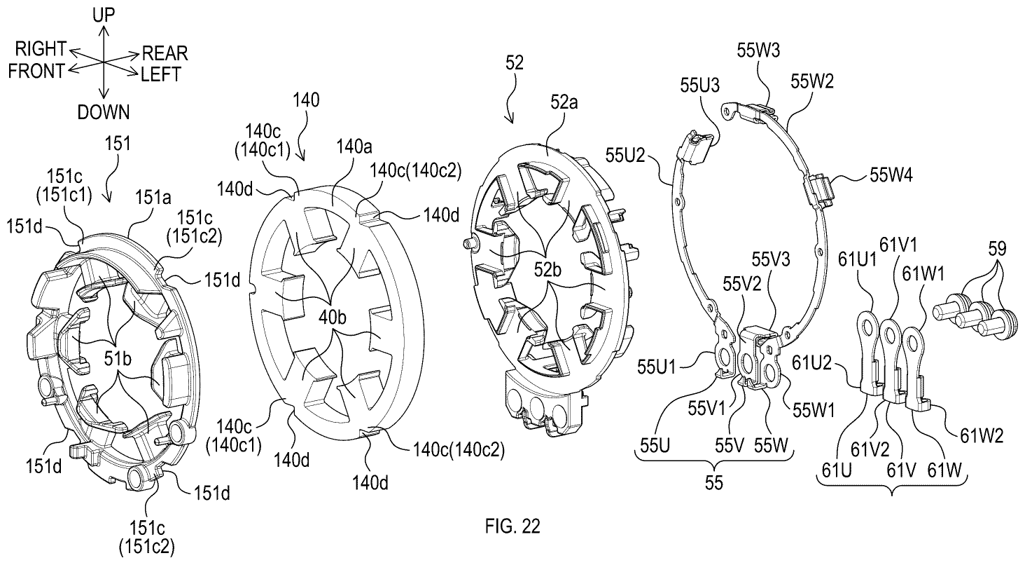

As shown in FIG. 22, the second stator core 140 includes a second yoke 140a and the teeth 40b. The second yoke 140a has a cylindrical or annular shape. The second yoke 140a is arranged such that its center coincides with the rotation axis AX.

The teeth 40b on the second stator core 140 have the same configuration as that of the teeth 40b on the stator core 40. Thus, the description here is not repeated.

As shown in FIG. 22, the modified first insulator 151 and the second insulator 52 are formed separately, and fixed to the second stator core 140. The modified first insulator 151 and the second insulator 52 are made of synthetic resin but may alternatively be made of another electrical insulating material. The modified first insulator 151 has a shape that covers a front side of the second stator core 140. The second insulator 52 has a shape that covers a rear side of the second stator core 140.

The modified first insulator 151 is fixed to the second stator core 140 at the front side of the second stator core 140, and covers a front side surface of the second stator core 140. The second insulator 52 is fixed to the second stator core 140 at the rear side of the second stator core 140, and covers a rear side surface of the second stator core 140.

As shown in FIGS. 18, 21, and 22, the modified first insulator 151 includes a modified first main portion 151a and the first teeth 51b. The modified first main portion 151a has a cylindrical or annular shape. The modified first main portion 151a is arranged such that its center coincides with the rotation axis AX.

The first teeth 51b in the modified first insulator 151 have the same configuration as that of the first teeth 51b in the first insulator 51. Thus, the description here is not repeated.

The second insulator 52 of the second stator 130 has the same configuration as that of the second insulator 52 of stator 30. Thus, the description here is not repeated.

Similar to the stator 30, the second stator 130 has six stator teeth. Similar to the stator 30, the second stator 130 includes a multiple of three slots (including three slots). Since the second stator 130 has six stator teeth, the second stator 130 has six slots. Each of the six slots corresponds to a gap between the two stator teeth adjacent to each other.

### 2-2-6. Coils

The coils 34 in the second stator 130 have the same configuration as those of the coils 34 in the stator 30. Thus, the description here is not repeated. The six coils 34 are electrically insulated from the second stator core 140 by the modified first insulator 151 and the second insulator 52.

The conductive member 55, the three power supply terminals 61, and the three fixation screws 59 in the second stator 130 respectively have configurations identical to those of their corresponding components in the stator 30. Thus, the description here is not repeated.

### 2-2-7. Circuit Board

The circuit board 62 of the second motor unit 120 has the same configuration as that of the circuit board 62 of the motor unit 20. Thus, the description here is not repeated.

### 2-2-8. Abutment Portions of Stator Core and First Insulator

As shown in FIGS. 18, 20 through 23, and 26, the second yoke 140a of the second stator core 140 includes exposed abutment portions 140c. The exposed abutment portions 140c are provided in a specified region on a front side surface of the second yoke 140a. The exposed abutment portions 140c include two first exposed abutment portions 140c1 and two third exposed abutment portions 140c2. The two first exposed abutment portions 140c1 are arranged in a right side region on the front side surface of the second yoke 140a. The two third exposed abutment portions 140c2 are arranged in a left side region on the front side surface of the second yoke 140a.

The modified first main portion 151a of the modified first insulator 151 includes blanks 151d. Each of the blanks 151d penetrates from a front surface to a rear surface of the modified first main portion 151a to expose a portion of the front side surface of the second stator core 140. Each of the blanks 151d extends radially inward from an outer circumferential edge of the modified first main portion 151a. In the present second embodiment, the blanks 151d includes four blanks 151d.

Each of the exposed abutment portions 140c is a region on the front side surface of the second yoke 140a exposed by a corresponding one of the blanks 151d. Each of the exposed abutment portions 140c extends radially inward from an outer circumferential edge of the front side surface of the second yoke 140a.

As shown in FIGS. 18, 20 through 24, 27 and 29, the second yoke 140a includes outer circumferential recesses 140d. The outer circumferential recesses 140d are recessed radially inward on an outer circumferential surface of the second yoke 140a. The outer circumferential recesses 140d penetrate the second yoke 140a from its front side surface to its rear side surface. The outer circumferential recesses 140d are arranged at specified intervals on the outer circumferential surface of the second yoke 140a.

The modified first main portion 151a includes modified abutment portions 151c. The modified abutment portions 151c are formed in a region corresponding to the outer circumferential recesses 140d of the modified first main portion 151a. The modified abutment portions 151c are arranged at specified intervals on the outer circumferential surface of the modified first main portion 151a. The modified abutment portions 151c include two modified second abutment portions 151c1 and two modified fourth abutment portions 151c2. The two modified second abutment portions 151c1 are arranged in a right side region of the outer circumferential surface of the modified first main portion 151a. The two modified fourth abutment portions 151c2 are arranged in a left side region of the outer circumferential surface of the modified first main portion 151a.

### 2-2-9. Fixing of Motor to Housing

Referring to FIGS. 17 through 29, fixing of the second motor 125 (the second stator 130 and the rotor 70, in detail) to the second housing 190 (the second right-partial housing 191 and the second left-partial housing 192, in detail) will be described.

By assembling the second right-partial housing 191 onto the second motor 125 from the right side, and further assembling the second left-partial housing 192 onto the second motor 125 from the left side, the second motor 125 is fixed between the second right-partial housing 191 and the second left-partial housing 192. At this point in time, the second stator 130 and the rotor 70 are separately fixed to the second housing 190.

The second stator 130 is assembled onto the second right-partial housing 191 with each of the two first exposed abutment portions 140c1 being in contact with or close to a corresponding one of the two modified first protruding portions 191a and each of the two modified second abutment portions 151c1 being in contact with or close to a corresponding one of the two modified second protruding portions 191b. In addition, the second stator 130 is assembled onto the second left-partial housing 192 with each of the two third exposed abutment portions 140c2 being in contact with or close to a corresponding one of the two modified third protruding portions 192a and each of the two modified fourth abutment portions 151c2 being in contact with or close to a corresponding one of the two modified fourth protruding portions 192b.

The second stator 130 is restrained from moving forward inside the second housing 190 when at least one of the two first exposed abutment portions 140cl abuts on at least one of the two modified first protruding portions 191a and at least one of the two third exposed abutment portions 140c2 abuts on at least one of the two modified third protruding portions 192a.

The second stator 130 is restrained from moving rearward inside the second housing 190 when at least one of the two modified second abutment portions 151c1 abuts on at least one of the two modified second protruding portions 191b and at least one of the two modified fourth abutment portions 151c2 abuts on at least one of the two modified fourth protruding portions 192b.

Two of the outer circumferential recesses 140d provided in the right side region of the second stator core 140 correspond to the two modified fifth protruding portions 191c of the second right-partial housing 191. The second stator 130 is assembled onto the second right-partial housing 191 with each of the two outer circumferential recesses 140d provided in the right side region of the second stator core 140 being in contact with or close to a corresponding one of the two modified fifth protruding portions 191c.

Two of the outer circumferential recesses 140d provided in the left side region of the second stator core 140 correspond to the two modified sixth protruding portions 192c of the second left-partial housing 192. The second stator 130 is assembled onto the second left-partial housing 192 with each of the two outer circumferential recesses 140d provided in the left side region of the second stator core 140 being in contact with or close to a corresponding one of the two modified sixth protruding portions 192c.

The second stator 130 is restrained from moving in the circumferential direction of the rotation axis AX inside the second housing 190 when at least one of the outer circumferential recesses 140d abuts on at least one of the two modified fifth protruding portions 191c or at least one of the two modified sixth protruding portions 192c. Circumferential movement restrained at this point in time includes movements in both the first rotation direction and the second rotation direction (see FIG. 2).

As a result, the second stator 130 maintains constant axial and circumferential positions relative to the second housing 190.

The rotor 70 is assembled onto the second housing 190 with the front bearing 25a abutting on the front bearing abutment portion 91d1 of the front bearing supporter 91d and the front bearing abutment portion 92d1 of the front bearing supporter 92d and with the rear bearing 25b abutting on the rear bearing abutment portion 91e1 of the rear bearing supporter 91e and the rear bearing abutment portion 92e1 of the rear bearing supporter 92e.

### 2-2-10. Effects

(1) According to the second embodiment described above, the same effects as those in the above-described first embodiment are achieved.

### 2-2-11. Correspondence Between Terms

The second motor 125 corresponds to an example of the brushless DC motor in Overview of Embodiments. The second right-partial housing 191 corresponds to an example of the first partial housing in Overview of Embodiments. The second left-partial housing 192 corresponds to an example of the second partial housing in Overview of Embodiments.

The first exposed abutment portions 140c1 and the third exposed abutment portions 140c2 each correspond to an example of the at least one exposed abutment portion in Overview of Embodiments.

Each of the two outer circumferential recesses 140d provided in the right side region of the second stator core 140 corresponds to an example of the at least one fifth abutment portion in Overview of Embodiments. Each of the two outer circumferential recesses 140d provided in the left side region of the second stator core 140 corresponds to an example of the at least one sixth abutment portion in Overview of Embodiments.

### 2-3. Third Embodiment 2-3-1. Differences from First Embodiment

The third embodiment has a basic configuration similar to that of the first embodiment, and the following describes the differences from the first embodiment. The same reference numerals as those in the first embodiment indicate the same components, and references are made to the preceding descriptions.

A third electric work machine 201 of the third embodiment differs from the electric work machine 1 of the first embodiment in that the third electric work machine 201 includes a third motor unit 220 in place of the motor unit 20.

### 2-3-2. Configuration of Motor Unit

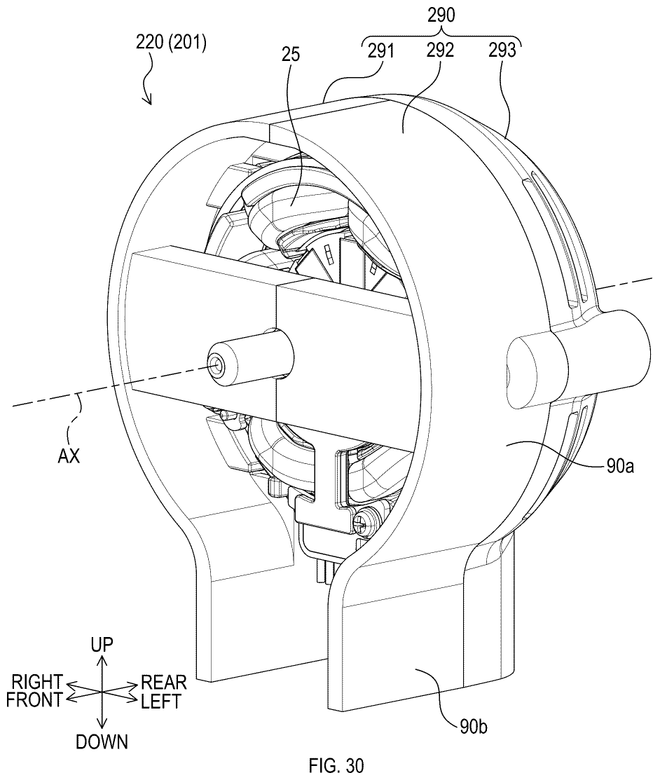

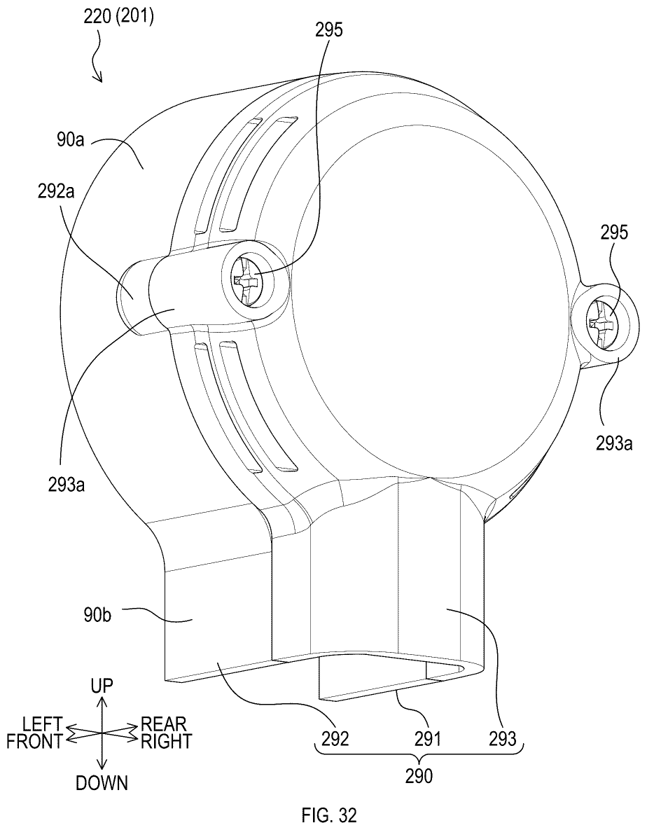

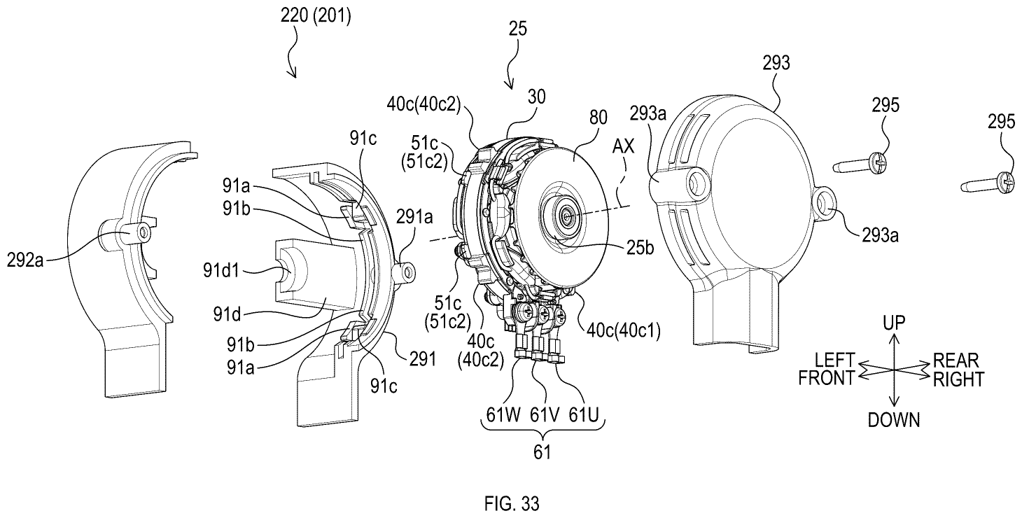

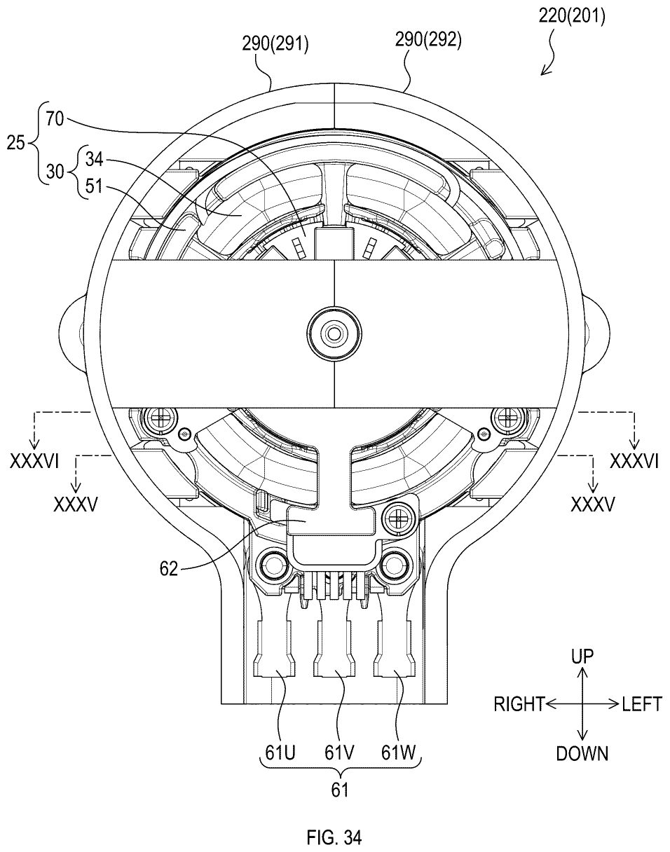

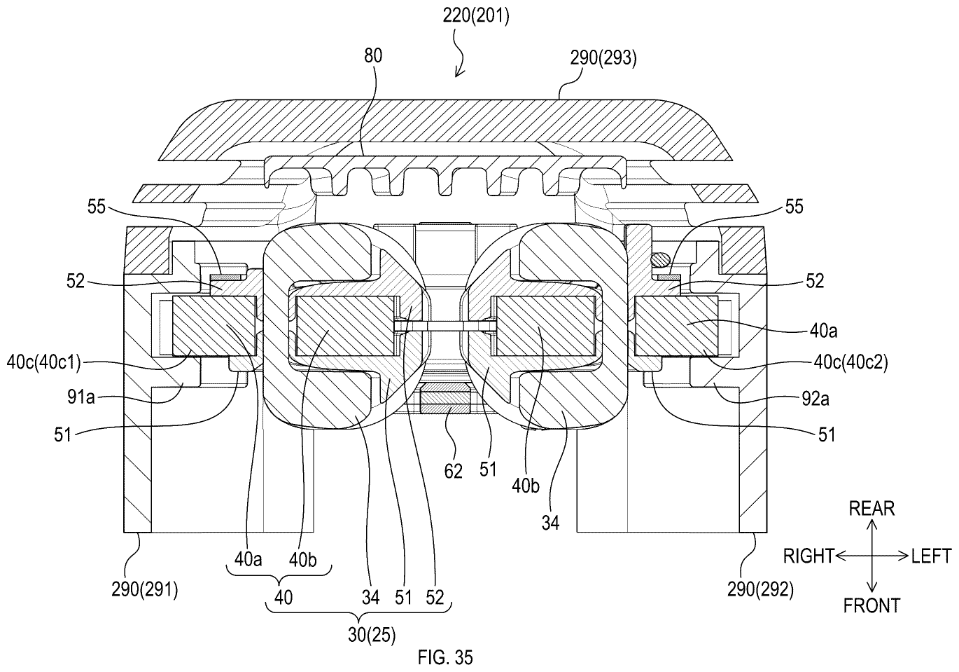

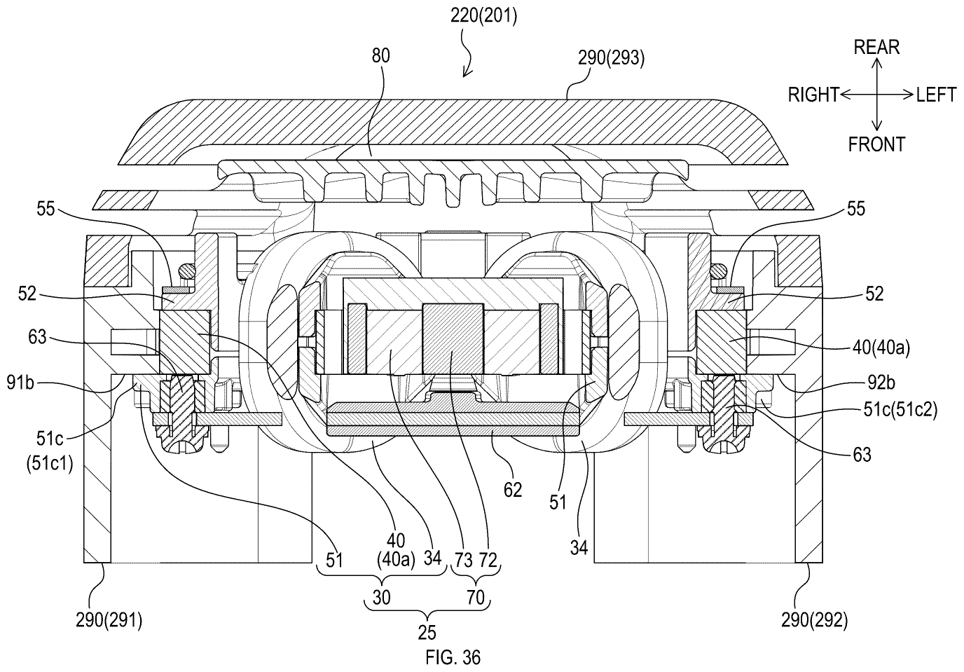

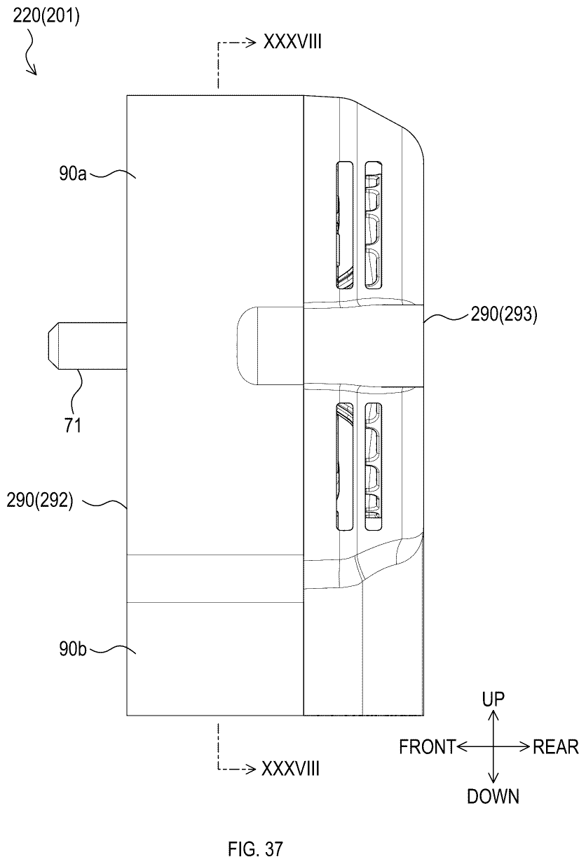

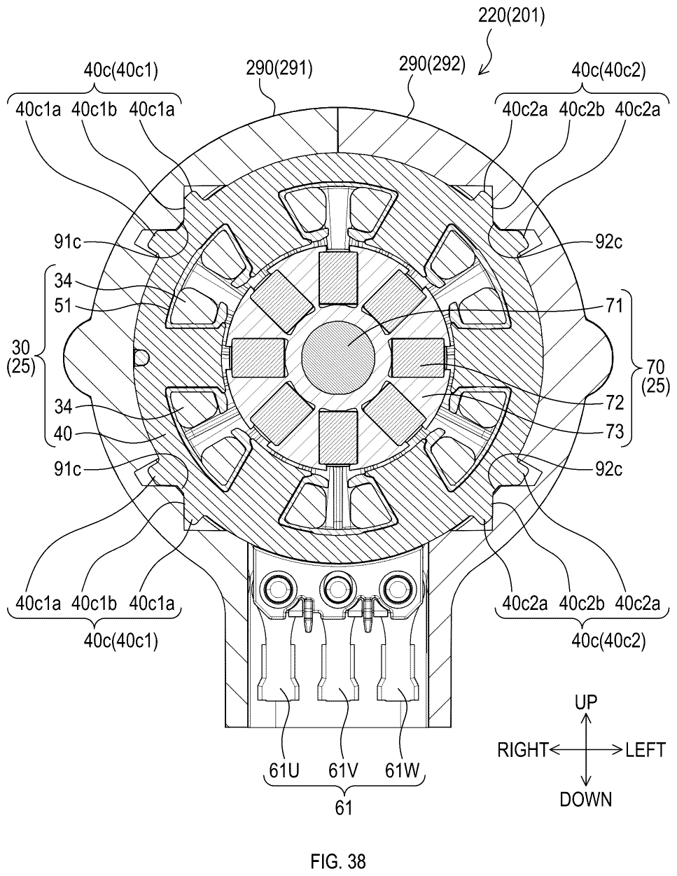

As shown in FIGS. 30 through 38, the third motor unit 220 differs from the motor unit 20 in that the third motor unit 220 includes a third housing 290 in place of the housing 90.

The third motor unit 220 includes the motor 25, the fan 80, the circuit board 62, and the third housing 290.

The motor 25, the fan 80, and the circuit board 62 respectively have configurations identical to those of their corresponding components in the first embodiment. Thus, the description here is not repeated.

### 2-3-3. Housing

As shown in FIGS. 30, 32, 34, and 37, the third housing 290 is configured to accommodate the motor 25 therein.

In terms of its appearance, the third housing 290 includes the cylindrical portion 90a and the protruding portion 90b, similar to the housing 90.

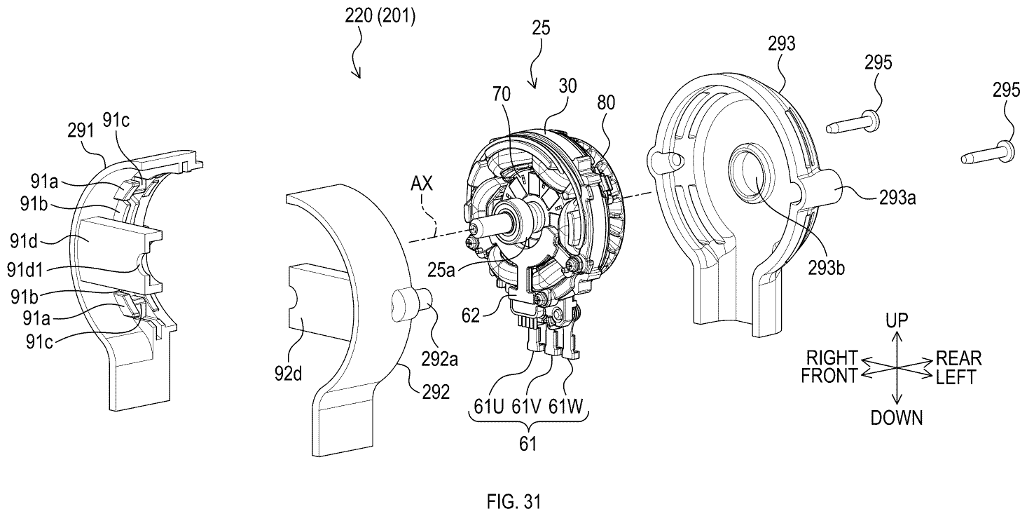

As shown in FIGS. 31, 33 through 37, the third housing 290 is configured to be separable into a third right-partial housing 291, a third left-partial housing 292, and a rear-partial housing 293. The third right-partial housing 291 forms a front right side part of the third housing 290. The third left-partial housing 292 forms a front left side part of the third housing 290. The rear-partial housing 293 forms a rear part of the third housing 290.

The third right-partial housing 291 is assembled onto the stator 30 of the motor 25 from the right side. The third left-partial housing 292 is assembled onto the stator 30 of the motor 25 from the left side. The third left-partial housing 292 is arranged to face the third right-partial housing 291.

The rear-partial housing 293 is assembled onto the third right-partial housing 291 and the third left-partial housing 292 assembled together from the rear. In other words, the rear-partial housing 293 is assembled from the rear onto the rear bearing 25b of the motor 25 which is supported by the third right-partial housing 291 and the third left-partial housing 292.

The third right-partial housing 291 includes a screw fixing portion 291a on the right rear side. The third left-partial housing 292 includes a screw fixing portion 292a on the left rear side. The rear-partial housing 293 includes a screw insertion portion 293a at each of its right and left side ends.

The third right-partial housing 291, the third left-partial housing 292, and the rear-partial housing 293 are coupled to each other by two connecting screws 295 when assembled together. One of the two connecting screws 295 is screwed into the screw fixing portion 291a through the corresponding screw insertion portion 293a. The other of the two connecting screws 295 is screwed into the screw fixing portion 292a through the corresponding screw insertion portion 293a.

The third housing 290 is configured to accommodate the motor 25 in an internal space surrounded by the third right-partial housing 291, the third left-partial housing 292, and the rear-partial housing 293.

As shown in FIGS. 31, 33, 35, and 36, the third right-partial housing 291 includes the two first protruding portions 91a, the second protruding portion 91b, the two fifth protruding portions 91c, and the front bearing supporter 91d, similar to the right-partial housing 91. The third left-partial housing 292 includes the two third protruding portions 92a, the fourth protruding portion 92b, the two sixth protruding portions 92c, and the front bearing supporter 92d, similar to the left-partial housing 92.

As shown in FIG. 31, the rear-partial housing 293 includes a rear bearing supporter 293b. The rear bearing supporter 293b is formed on a rear inner surface of the rear-partial housing 293. The rear bearing supporter 293b is configured to abut on the rear bearing 25b of the motor 25. The rear bearing supporter 293b has the same configuration as that of the rear bearing abutment portion 91e1 of the rear bearing supporter 91e and the rear bearing abutment portion 92e1 of the rear bearing supporter 92e.

In other words, the third housing 290 has the same inner structure as that of the housing 90.

### 2-3-4. Fixing of Motor to Housing

Referring to FIGS. 30 through 38, fixing of the motor 25 (the stator 30 and the rotor 70, in detail) to the third housing 290 (the third right-partial housing 291, the third left-partial housing 292, and the rear-partial housing 293, in detail) will be described.

The motor 25 is fixed between the third right-partial housing 291 and the third left-partial housing 292 when the third right-partial housing 291 is assembled onto the motor 25 from the right side and the third left-partial housing 292 is assembled onto the motor 25 from the left side. Thereafter, the rear-partial housing 293 is assembled onto the third right-partial housing 291 and the third left-partial housing 292 from the rear, and these housings are coupled by the two connecting screws 295.

As a result, the stator 30 and the rotor 70 are separately fixed to the third housing 290.

In the third motor unit 220 configured as above, similar to the motor unit 20, when at least one of the two first abutment portions 40c1 abuts on at least one of the two first protruding portions 91a and at least one of the two third abutment portions 40c2 abuts on at least one of the two third protruding portions 92a, the stator 30 is restrained from moving forward inside the third housing 290.

Also, in the third motor unit 220, similar to the motor unit 20, when at least one of the two second abutment portions 51c1 abuts on the second protruding portion 91b and at least one of the two fourth abutment portions 51c2 abuts on the fourth protruding portion 92b, the stator 30 is restrained from moving rearward inside the third housing 290.

Further, in the third motor unit 220, similar to the motor unit 20, when at least one of the two first abutment portions 40c1 abuts on at least one of the two fifth protruding portions 91c and at least one of the two third abutment portions 40c2 abuts on at least one of the two sixth protruding portions 92c, the stator 30 is restrained from moving in the circumferential direction of the rotation axis AX inside the third housing 290.

As a result, in the third motor unit 220, similar to the motor unit 20, the stator 30 maintains constant axial and circumferential positions relative to the third housing 290.

The rotor 70 is assembled onto the third housing 290 with the front bearing 25a abutting on the front bearing abutment portion 91d1 of the front bearing supporter 91d and the front bearing abutment portion 92d1 of the front bearing supporter 92d and with the rear bearing 25b abutting on the rear bearing supporter 293b.

### 2-3-5. Effects

(1) According to the third embodiment described above, the same effects as those in the above-described first embodiment are achieved.

(2) The third housing 290 includes the third right-partial housing 291, the third left-partial housing 292, and the rear-partial housing 293. The rear-partial housing 293 is configured to support the rear bearing 25b of the motor 25.

Thus, by removing the rear-partial housing 293 from the third housing 290 which houses the motor 25, the rotor 70 of the motor 25 can be removed from the rear of the third housing 290. Alternatively, the rotor 70 can be inserted from the rear into the stator 30 held by the third housing 290 (in other words, the third right-partial housing 291 and the third left-partial housing 292) without the rear-partial housing 293.

### 2-3-6. Correspondence Between Terms

The third right-partial housing 291 corresponds to an example of the first partial housing in Overview of Embodiments. The third left-partial housing 292 corresponds to an example of the second partial housing in Overview of Embodiments. The rear-partial housing 293 corresponds to an example of the third partial housing in Overview of Embodiments.

The front bearing 25a corresponds to an example of the first bearing in Overview of Embodiments, and the rear bearing 25b corresponds to an example of the second bearing in Overview of Embodiments.

### 2-4. Fourth Embodiment

### 2-4-1. Differences from Second Embodiment

The fourth embodiment has a basic configuration similar to that of the second embodiment, and the following describes the differences from the second embodiment. The same reference numerals as those in the second embodiment indicate the same components, and references are made to the preceding descriptions.

The fourth electric work machine 301 of the fourth embodiment differs from the second electric work machine 101 of the second embodiment in that the fourth electric work machine 301 includes a fourth motor unit 320 in place of the second motor unit 120.

### 2-4-2. Configuration of Motor Unit

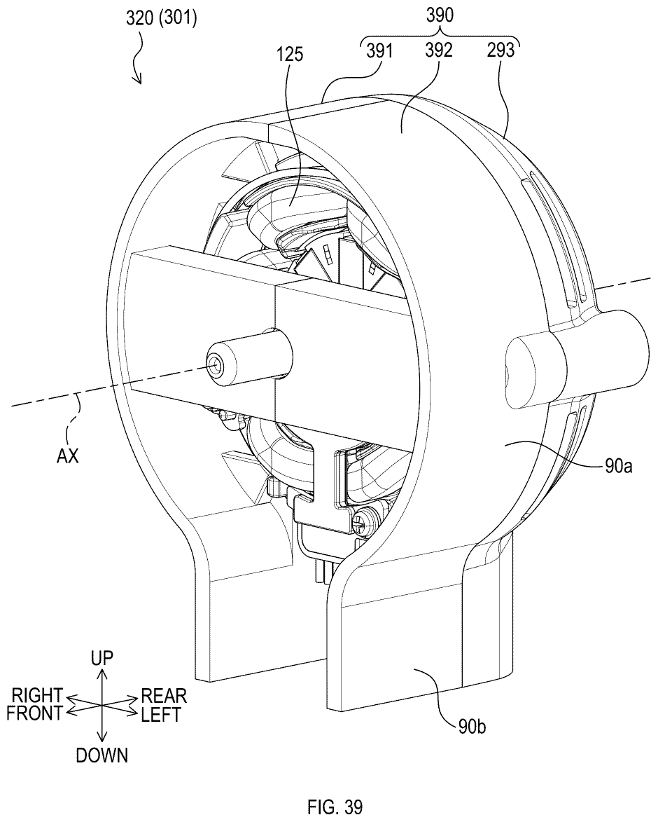

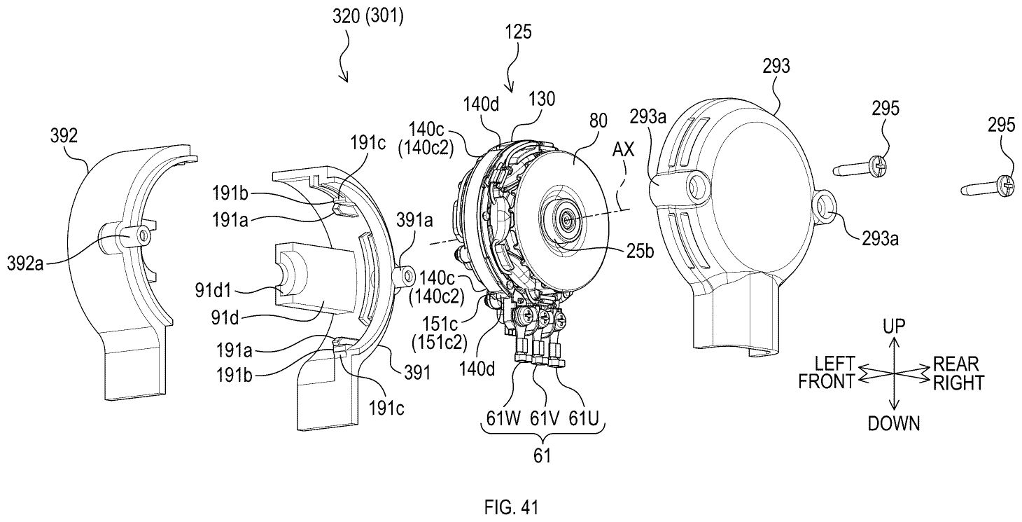

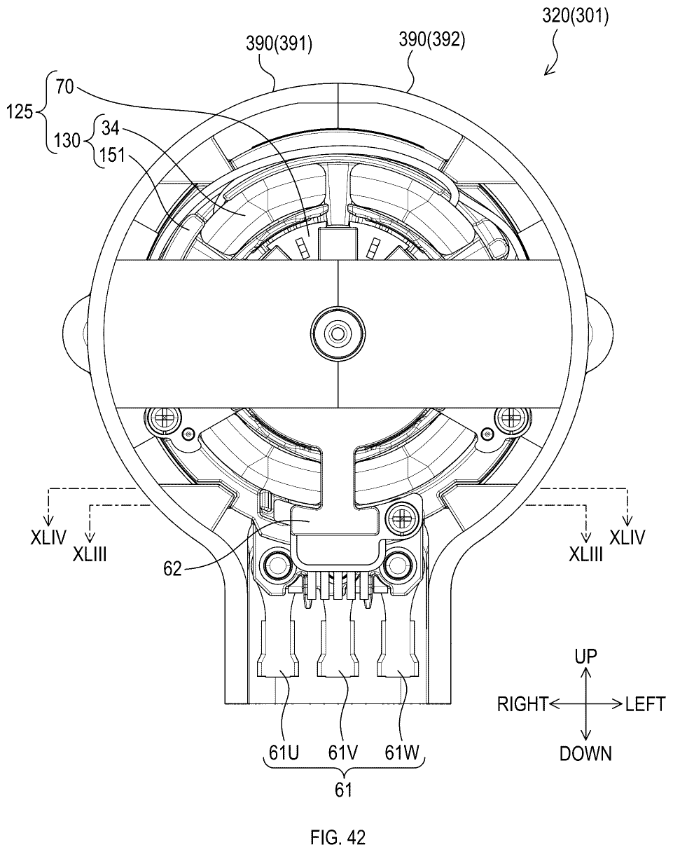

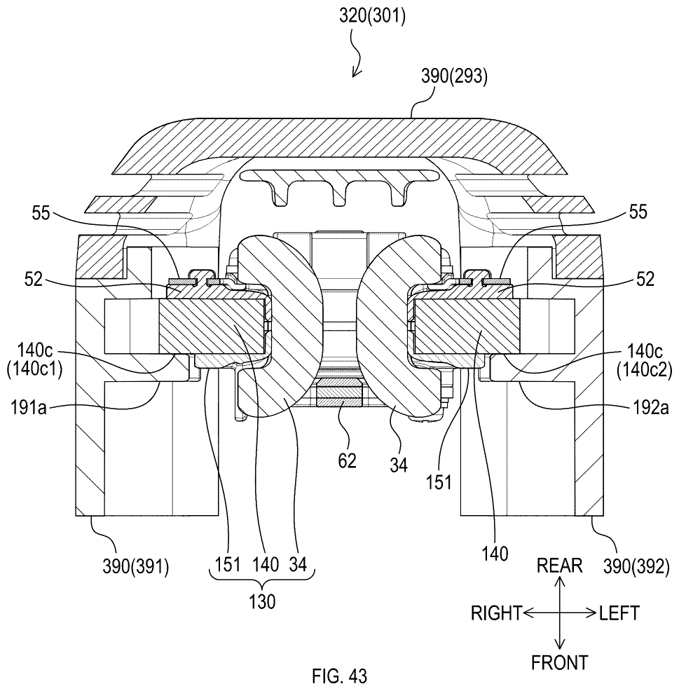

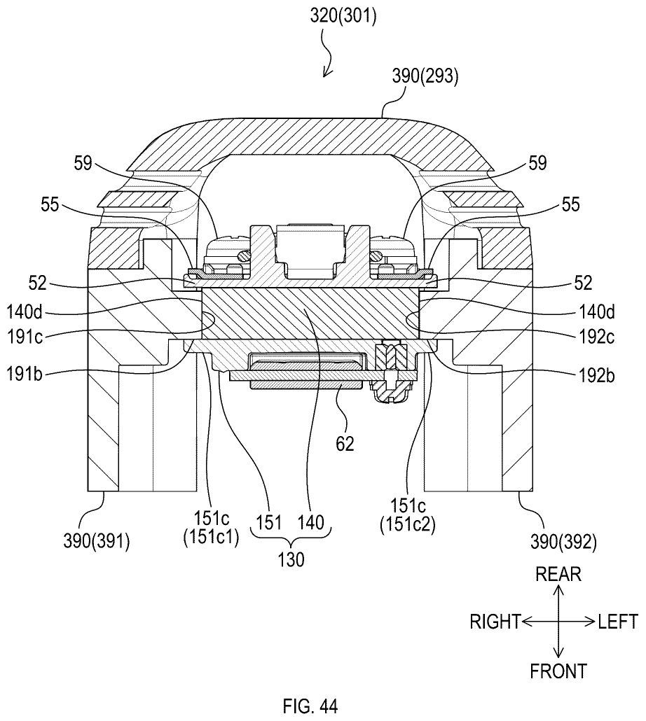

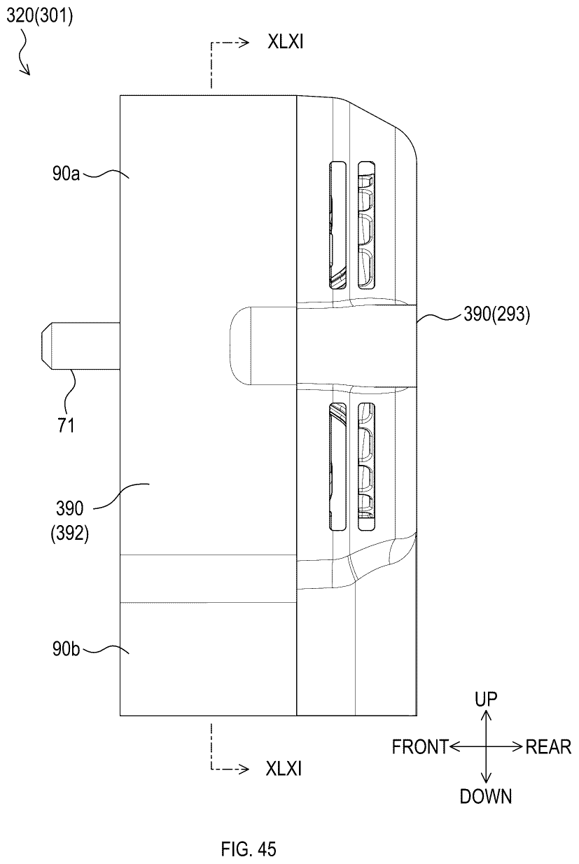

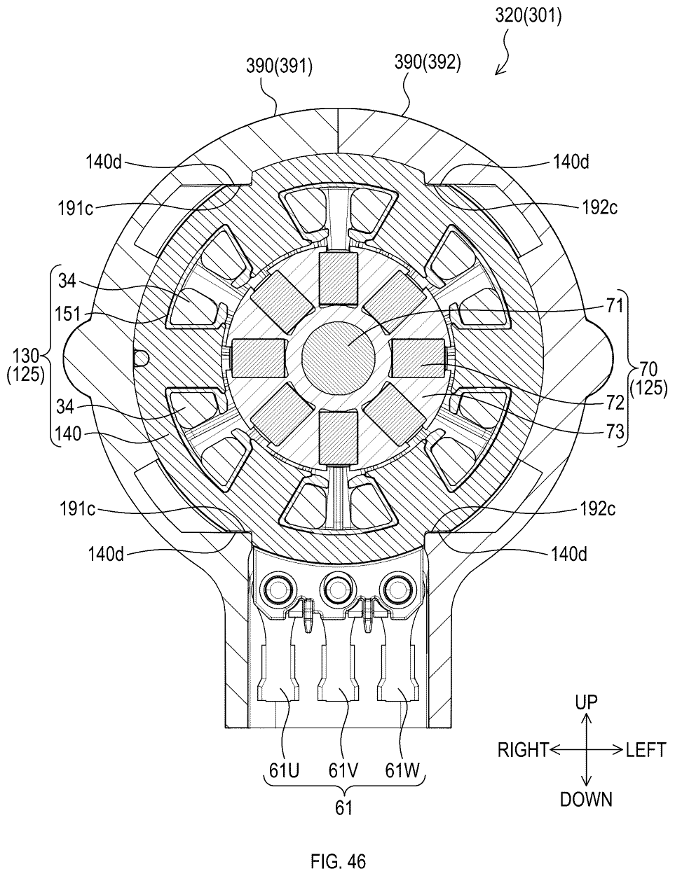

As shown in FIGS. 39 through 46, the fourth motor unit 320 differs from the second motor unit 120 in that the fourth motor unit 320 includes a fourth housing 390 in place of the second housing 190.

The fourth motor unit 320 includes the second motor 125, the fan 80, the circuit board 62, and the fourth housing 390.

The second motor 125, the fan 80, and the circuit board 62 respectively have configurations identical to those of their corresponding components in the second embodiment. Thus, the description here is not repeated.

### 2-4-3. Housing

As shown in FIGS. 39, 42, and 45, the fourth housing 390 is configured to accommodate the second motor 125 therein.

In terms of its appearance, the fourth housing 390 includes the cylindrical portion 90a and the protruding portion 90b, similar to the second housing 190.

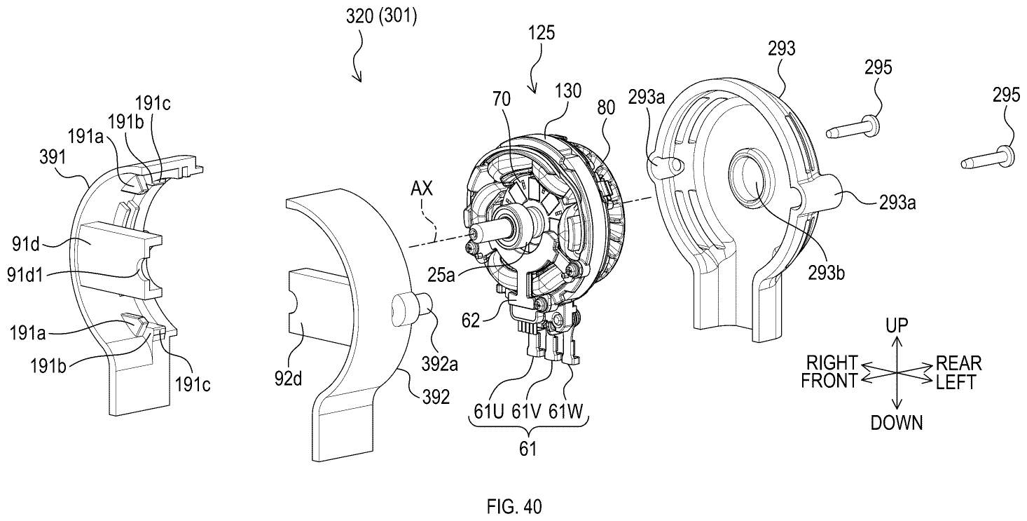

As shown in FIGS. 40 through 44, and 46, the fourth housing 390 is configured to be separable into a fourth right-partial housing 391, a fourth left-partial housing 392, and the rear-partial housing 293. The fourth right-partial housing 391 forms a front right side part of the fourth housing 390. The fourth left-partial housing 392 forms a front left side part of the fourth housing 390. The rear-partial housing 293 forms a rear part of the fourth housing 390.

The fourth right-partial housing 391 is assembled onto the second stator 130 of the second motor 125 from the right side. The fourth left-partial housing 392 is assembled onto the second stator 130 of the second motor 125 from the left side. The fourth left-partial housing 392 is arranged to face the fourth right-partial housing 391.

The rear-partial housing 293 is assembled onto the fourth right-partial housing 391 and the fourth left-partial housing 392 assembled together from the rear. In other words, the rear-partial housing 293 is assembled from the rear onto the rear bearing 25b of the second motor 125 supported by the fourth right-partial housing 391 and the fourth left-partial housing 392.

The rear-partial housing 293 of the fourth embodiment has the same configuration as that of the rear-partial housing 293 of the third embodiment.

The fourth right-partial housing 391 includes a screw fixing portion 391a on the right rear side. The fourth left-partial housing 392 includes a screw fixing portion 392a on the left rear side. The rear-partial housing 293 includes a screw insertion portion 293a at each of its right and left side ends.

The fourth right-partial housing 391, the fourth left-partial housing 392, the rear-partial housing 293 are coupled to each other by two connecting screws 295 when assembled together. One of the two connecting screws 295 is screwed into the screw fixing portion 391a through the corresponding screw insertion portion 293a. The other of the two connecting screws 295 is screwed into the screw fixing portion 392a through the corresponding screw insertion portion 293a.

The fourth housing 390 is configured to accommodate the second motor 125 in an internal space surrounded by the fourth right-partial housing 391, the fourth left-partial housing 392, and the rear-partial housing 293.

As shown in FIGS. 40, 41, 43, and 44, the fourth right-partial housing 391 includes the two modified first protruding portions 191a, the two modified second protruding portions 191b, the two modified fifth protruding portions 191c, and the front bearing supporter 91d, similar to the second right-partial housing 191. The fourth left-partial housing 392 includes the two modified third protruding portions 192a, the two modified fourth protruding portions 192b, the two modified sixth protruding portions 192c, and the front bearing supporter 92d, similar to the second left-partial housing 192.

As shown in FIG. 40, the rear-partial housing 293 includes a rear bearing supporter 293b. The rear bearing supporter 293b is formed on a rear inner surface of the rear-partial housing 293. The rear bearing supporter 293b is configured to abut on the rear bearing 25b of the second motor 125.

In other words, the fourth housing 390 has the same inner structure as that of the second housing 190.

### 2-4-4. Fixing of Motor to Housing

Referring to FIGS. 39 through 46, fixing of the second motor 125 (the second stator 130 and the rotor 70, in detail) to the fourth housing 390 (the third right-partial housing 291, the fourth left-partial housing 392, and the rear-partial housing 293, in detail) will be described.

The second motor 125 is fixed between the fourth right-partial housing 391 and the fourth left-partial housing 392 by assembling the fourth right-partial housing 391 onto the second motor 125 from the right side and further assembling the fourth left-partial housing 392 onto the second motor 125 from the left side. Thereafter, the rear-partial housing 293 is assembled onto the fourth right-partial housing 391 and the fourth left-partial housing 392 from the rear, and these housings are coupled by the two connecting screws 295.

As a result, the second stator 130 and the rotor 70 are separately fixed to the fourth housing 390.

In the fourth motor unit 320 configured as above, similar to the second motor unit 120, the second stator 130 is restrained from moving forward inside the fourth housing 390 when at least one of the two first exposed abutment portions 140c1 abuts on at least one of the two modified first protruding portions 191a and at least one of the two third exposed abutment portions 140c2 abuts on at least one of the two modified third protruding portions 192a.

Also, in the fourth motor unit 320, similar to the second motor unit 120, the second stator 130 is restrained from moving rearward inside the fourth housing 390 when at least one of the two modified second abutment portions 151c1 abuts on at least one of the two modified second protruding portions 191b and at least one of the two modified fourth abutment portions 151c2 abuts on at least one of the two modified fourth protruding portions 192b.

Further, in the fourth motor unit 320, similar to the second motor unit 120, the second stator 130 is restrained from moving in the circumferential direction of the rotation axis AX inside the fourth housing 39 when at least one of the outer circumferential recesses 140d abuts on at least one of the two modified fifth protruding portions 191c or at least one of the two modified sixth protruding portions 192c.

As a result, in the fourth motor unit 320, similar to the second motor unit 120, the second stator 130 maintains constant axial and circumferential positions relative to the fourth housing 390.

The rotor 70 is assembled onto the fourth housing 390 with the front bearing 25a abutting on the front bearing abutment portion 91d1 of the front bearing supporter 91d and the front bearing abutment portion 92d1 of the front bearing supporter 92d and with the rear bearing 25b abutting on the rear bearing supporter 293b.

### 2-4-5. Effects

(1) According to the fourth embodiment described above, the same effects as those in the above-described first embodiment and third embodiment are achieved.

### 2-4-6. Correspondence Between Terms

The fourth right-partial housing 391 corresponds to an example of the first partial housing in Overview of Embodiments. The fourth left-partial housing 392 corresponds to an example of the second partial housing in Overview of Embodiments.

### 2-5. Other Embodiments

The embodiments of the present disclosure have been described in the above. The present disclosure is not limited to the above-described embodiments, and can be practiced in various forms.

(a) In the above-described first and third embodiments, the first abutment portion and the third abutment portion include the protruding abutment portion. In the above-described second and fourth embodiments, the first abutment portion and the third abutment portion include the exposed abutment portion. However, the present disclosure is not limited to these. For example, the first abutment portion may include the protruding abutment portion, and the third abutment portion may include the exposed abutment portion. Alternatively, the first abutment portion may include the protruding abutment portion and the exposed abutment portion, and the third abutment portion may include the protruding abutment portion and the exposed abutment portion.

(b) In the above-described embodiments, the stator core includes two first abutment portions. However, the present disclosure is not limited to this. For example, the stator core may include a single first abutment portion or three or more first abutment portions.

Similarly, the stator core does not necessarily include two third abutment portions, and may include a single third abutment portion or three or more third abutment portions.

(c) In the above-described embodiments, the insulator includes two second abutment portions. However, the present disclosure is not limited to this. For example, the insulator may include a single second abutment portion or three or more second abutment portions.

Similarly, the insulator does not necessarily include two fourth abutment portions, and may include a single fourth abutment portion or three or more fourth abutment portions.

(d) In the above-described embodiments, the first partial housing (in other words, the right-partial housing) includes two first protruding portions. However, the present disclosure is not limited to this. For example, the first partial housing may include a single first protruding portion or three or more first protruding portions.

Similarly, the first partial housing does not necessarily include two second protruding portions. For example, the first partial housing may include a single second protruding portion or three or more second protruding portions.

(e) In the above-described embodiments, the second partial housing (in other words, the left-partial housing) includes two third protruding portions. However, the present disclosure is not limited to this. For example, the second partial housing may include a single third protruding portion or three or more third protruding portions.

Similarly, the second partial housing does not necessarily include two fourth protruding portions. For example, the second partial housing may include a single fourth protruding portion or three or more fourth protruding portions.

(f) In the above-described embodiments, mutual abutment and mutual separation occur in each of the combination of the first protruding portion with the first abutment portion, the combination of the third protruding portion with the third abutment portion, the combination of the second protruding portion with the second abutment portion, and the combination of the fourth protruding portion with the fourth abutment portion. However, the present disclosure is not limited to this. For example, mutual abutments may be maintained in all of the combination of the first protruding portion with the first abutment portion, the combination of the third protruding portion with the third abutment portion, the combination of the second protruding portion with the second abutment portion, and the combination of the fourth protruding portion with the fourth abutment portion. Alternatively, at least one of the combination of the first protruding portion with the first abutment portion, the combination of the third protruding portion with the third abutment portion, the combination of the second protruding portion with the second abutment portion, and the combination of the fourth protruding portion with the fourth abutment portion may maintain at least one mutual abutment, and the others may undergo mutual abutment and separation.

(g) Two or more functions achieved by one element of the above-described embodiments may be achieved by two or more elements. One function achieved by one element may be achieved by two or more elements. Two or more functions achieved by two or more elements may be achieved by one element. One function achieved by two or more elements may be achieved by one element. A part of the configurations in the above-described embodiments may be omitted. At least a part of the configurations in one of the above-described embodiments may be added to or replaced with a part of the configurations in another one of the above-described embodiments.

What is claimed is:

1. An electric work machine comprising:
a brushless DC motor including a rotor configured to rotate about a rotation axis and a stator surrounding the rotor; and
a housing accommodating the brushless DC motor therein,
the stator including:
a stator core including a yoke surrounding the rotor and teeth radially protruding inward from the yoke with respect to the rotation axis; and
an insulator covering at least a portion of the stator core,
the housing including a first partial housing and a second partial housing facing the first partial housing, and accommodating the brushless DC motor between the first partial housing and the second partial housing,
the first partial housing including:
at least one first protruding portion protruding toward the brushless DC motor from an inner surface of the first partial housing; and
at least one second protruding portion protruding toward the brushless DC motor from the inner surface of the first partial housing, the at least one second protruding portion being located in a position different from that of the at least one first protruding portion in a circumferential direction of the rotation axis,
the second partial housing including:
at least one third protruding portion protruding toward the brushless DC motor from the inner surface of the second partial housing; and
at least one fourth protruding portion protruding toward the brushless DC motor from the inner surface of the second partial housing, the at least one fourth protruding portion being located in a position different from that of the at least one third protruding portion in the circumferential direction,
the stator core including:
at least one first abutment portion configured to abut on the at least one first protruding portion to thereby restrain the stator from moving in a first axial direction along the rotation axis with respect to the housing; and
at least one third abutment portion configured to abut on the at least one third protruding portion to thereby restrain the stator from moving in the first axial direction with respect to the housing,
the insulator including:
at least one second abutment portion configured to abut on the at least one second protruding portion to thereby restrain the stator from moving, with respect to the housing, in a second axial direction that is opposite to the first axial direction; and
at least one fourth abutment portion configured to abut on the at least one fourth protruding portion to thereby restrain the stator from moving in the second axial direction with respect to the housing.

2. The electric work machine according to claim 1, wherein:
each of the at least one first abutment portion and the at least one third abutment portion includes at least one protruding abutment portion and/or at least one exposed abutment portion;
the at least one protruding abutment portion outwardly protrudes from the yoke with respect to the rotation axis; and
the at least one exposed abutment portion is exposed from the insulator.

3. The electric work machine according to claim 2,
wherein each of the at least one first abutment portion includes:
two protruding abutment portions as the at least one protruding abutment portion;
two exposed abutment portions as the at least one exposed abutment portion; or
one protruding abutment portion as the at least one protruding abutment portion and one exposed abutment portion as the at least one exposed abutment portion.

4. The electric work machine according to claim 2,
wherein each of the at least one third abutment portion includes:
two protruding abutment portions as the at least one protruding abutment portion;
two exposed abutment portions as the at least one exposed abutment portion; or
one protruding abutment portion as the at least one protruding abutment portion and one exposed abutment portion as the at least one exposed abutment portion.

5. The electric work machine according to claim 1,
wherein each of the at least one second abutment portion and the at least one fourth abutment portion includes at least one outer arrangement portion arranged farther outward than the yoke in a radial direction of the rotation axis.

6. The electric work machine according to claim 5,
wherein each of the at least one second abutment portion includes two outer arrangement portions as the at least one outer arrangement portion.

7. The electric work machine according to claim 5,
wherein each of the at least one fourth abutment portion includes two outer arrangement portions as the at least one outer arrangement portion.

8. The electric work machine according to claim 1, wherein:
the brushless DC motor includes a rotational position sensor configured to detect a rotational position of the rotor;
the insulator includes;
a first insulator including the at least one second abutment portion and/or the at least one fourth abutment portion; and
a second insulator distinct from the first insulator; and
the rotational position sensor is fixed to the first insulator.

9. The electric work machine according to claim 8, wherein:
the stator includes:
coils wound around the teeth via the first insulator and the second insulator; and
a conductive member including a coupling portion coupled to the coils and a power receiving portion configured to receive electric power for the coils;
the first insulator, the stator core, and the second insulator are arranged in this order along the rotation axis; and
the conductive member is stacked on the yoke via the second insulator.

10. The electric work machine according to claim 8,
wherein the first insulator, the stator core, and the second insulator are configured to be separable from each other.

11. The electric work machine according to claim 1,
wherein the first partial housing and the second partial housing are formed of resin.

12. The electric work machine according to claim 1, wherein:
the brushless DC motor includes:
a first bearing rotatably supporting a first end of the rotor in the first axial direction; and
a second bearing rotatably supporting a second end of the rotor in the second axial direction;
the housing includes a third partial housing covering an end of the brushless DC motor in the second axial direction;
the first partial housing and/or the second partial housing supports the first bearing; and
the third partial housing supports the second bearing.

13. The electric work machine according to claim 1, wherein:
the first partial housing includes at least one fifth protruding portion protruding toward the brushless DC motor from the inner surface of the first partial housing;
the second partial housing includes at least one sixth protruding portion protruding toward the brushless DC motor from the inner surface of the second partial housing; and
the stator core includes:
at least one fifth abutment portion configured to abut on the at least one fifth protruding portion to thereby restrain the stator from moving in the circumferential direction with respect to the housing; and
at least one sixth abutment portion configured to abut on the at least one sixth protruding portion to thereby restrain the stator from moving in the circumferential direction with respect to the housing.

14. The electric work machine according to claim 1,
wherein the at least one first protruding portion of the first partial housing and the at least one third protruding portion of the second partial housing face each other across the brushless DC motor with the first partial housing and the second partial housing facing each other.

15. The electric work machine according to claim 1,
wherein the at least one second protruding portion of the first partial housing and the at least one fourth protruding portion of the second partial housing face each other across the brushless DC motor with the first partial housing and the second partial housing facing each other.

16. The electric work machine according to claim 1, wherein:
the first axial direction is a direction from the rotation axis toward a driven tool; and
the driven tool is configured to be driven by a rotational force of the brushless DC motor.

17. The electric work machine according to claim 1,
wherein the electric work machine is an electric impact driver.

18. The electric work machine according to claim 1, wherein:
the at least one first abutment portion and the at least one first protruding portion are configured to abut on each other or be separated from each other in response to a change in a relative position of the stator with respect to the housing along the rotation axis;
the at least one third abutment portion and the at least one third protruding portion are configured to abut on each other or be separated from each other in response to a change in the relative position of the stator with respect to the housing along the rotation axis;
the at least one second abutment portion and the at least one second protruding portion are configured to abut on each other or be separated from each other in response to a change in the relative position of the stator with respect to the housing along the rotation axis; and
the at least one fourth abutment portion and the at least one fourth protruding portion are configured to abut on each other or be separated from each other in response to a change in the relative position of the stator with respect to the housing along the rotation axis.
